(19) United States
(12) Patent Application Publication
(10) Pub. No.: US 2026/0127870 A1
(43) Pub. Date: May 7, 2026

(54) IMAGE GENERATION APPARATUS, IMAGE RECOGNITION APPARATUS, AND IMAGE RECOGNITION METHOD

(71) Applicant: Sony Group Corporation, Tokyo (JP)

(72) Inventors: Atsushi IRIE, Kanagawa (JP); Leo HOSHIKAWA, Kanagawa (JP); Junji OTSUKA, Kanagawa (JP); Masakazu YOSHIMURA, Kanagawa (JP)

(73) Assignee: Sony Group Corporation, Tokyo (JP)

(21) Appl. No.: 19/118,788

(22) PCT Filed: Feb. 6, 2024
(86) PCT No.: PCT/JP2024/003968

§ 371 Date: Apr. 7, 2025

(30) Foreign Application Priority Data
Mar. 10, 2023 (JP) 2023-037418

(51) Int. Cl. G06V 10/82; G06V 10/22

(52) U.S. Cl. CPC G06V 10/82; G06V 10/235

(57) ABSTRACT

An image generation apparatus including circuitry configured to acquire sensor data, and generate at least one output image in which recognition accuracy is reduced for at least one protection target in the acquired sensor data, wherein the recognition accuracy for the at least one protection target is reduced in each generated output image according to learning using a selected model to recognize a specified protection target corresponding to the at least one protection target.

### CROSS REFERENCE TO RELATED APPLICATIONS

This application claims the benefit of Japanese Priority Patent Application JP 2023-037418 filed on Mar. 10, 2023, the entire contents of which are incorporated herein by reference.

### TECHNICAL FIELD

The present disclosure relates to an image generation apparatus, an image recognition apparatus, and an image recognition method.

### BACKGROUND ART

Various tasks of performing recognition on the basis of sensor data obtained by a sensor have been known. For example, examples of the sensor include a camera, and examples of the task include person detection based on an image captured by the camera. While it is possible to increase, by learning, the accuracy of recognition by the task, it may be necessary to protect the privacy of a person in a case where the sensor data contains a feature of the person.

PTL 1 discloses a technique relating to learning based on an image information-reduced by tone reduction and contour extraction. According to such a technique, it is possible to obtain an image that allows protection of the privacy of a person while increasing the accuracy of recognition by the task.

Furthermore, NPL 1 discloses a technique of generating an image using a model obtained as a result of performing learning to reduce the accuracy of recognition. According to such a technique, it is possible to obtain an image that allows protection of the privacy of a person.

NPL 2 also discloses a technique of disabling recognition based on an image only in a case where a specific device such as a specific camera or a specific image signal processor (ISP) is used. According to such a technique, it is possible to protect the privacy of a person appearing in the image.

### CITATION LIST

### Patent Literature

PTL 1: JP 2022-96519 A

### Non Patent Literature

NPL 1: Ali Shahin Shamsabadi, et al. “EdgeFool: An Adversarial Image Enhancement Filter”, [online], [searched on Feb. 1, 2023], Internet <https://arxiv.org/pdf/1910.12227.pdf>
NPL 2: Buu Phan, et al. “Adversarial Imaging Pipelines”, [online], [searched on Feb. 1, 2023], Internet <https://arxiv.org/pdf/2102.03728.pdf>

### SUMMARY

### Technical Problem

Examples of the protection target, however, include a plurality of types of features such as the gender and age of a person. Then, there is also a possibility that it is desired to protect a specific feature among a plurality of types of features. It is therefore desirable to perform learning to reduce the accuracy of recognition of a specific protection target.

### Solution to Problem

According to the present disclosure, there is provided an image generation apparatus that includes circuitry configured to acquire sensor data, and generate at least one output image in which recognition accuracy is reduced for at least one protection target in the acquired sensor data, wherein the recognition accuracy for the at least one protection target is reduced in each generated output image according to learning using a selected model to recognize a specified protection target corresponding to the at least one protection target.

Furthermore, according to the present disclosure, there is provided an image recognition apparatus that includes circuitry configured to receive at least one output image in which recognition accuracy is reduced for at least one protection target in sensor data, and perform recognition related to the at least one protection target in the at least one output image, wherein the recognition accuracy for the at least one protection target is reduced in each generated output image according to learning using a selected model to recognize a specified protection target corresponding to the at least one protection target.

In addition, according to the present disclosure, there is provided an image recognition method including receiving at least one output image in which recognition accuracy is reduced for at least one protection target in sensor data, and performing recognition related to the at least one protection target in the at least one output image, wherein the recognition accuracy for the at least one protection target is reduced in each generated output image according to learning using a selected model to recognize a specified protection target corresponding to the at least one protection target.

### BRIEF DESCRIPTION OF DRAWINGS

FIG. 1 is a diagram for describing a typical recognition system.

FIG. 2 is a diagram for describing a first example of privacy information that can be a protection target.

FIG. 3 is a diagram for describing a second example of the privacy information that can be the protection target.

FIG. 4 is a diagram for describing a third example of the privacy information that can be the protection target.

FIG. 5 is a diagram for describing an example of image generation according to a comparative example.

FIG. 6 is a diagram for describing an example of image generation according to an embodiment of the present disclosure.

FIG. 7 is a diagram for describing a first example of a loss used in learning.

FIG. 8 is a diagram for describing a second example of the loss used in learning.

FIG. 9 is a diagram illustrating a functional configuration example of an information processing apparatus 10 according to a first embodiment of the present disclosure.

FIG. 10 is a diagram for describing an example of calculation of L_{identify} in a case where a personal authentication model M1 is selected.

FIG. 11 is a diagram for describing an example of calculation of L_{identify} in a case where a gender authentication model M2 is selected.

FIG. 12 is a diagram for describing an example of calculation of L_{identify} in a case where an age authentication model M3 is selected.

FIG. 13 is a diagram for describing an example of calculation of L_{identify} in a case where a similarity calculation model M4 is selected.

FIG. 14 is a flowchart illustrating a flow of processing at the time of learning (operation of performing learning online during imaging) performed by the information processing apparatus 10 according to the first embodiment of the present disclosure.

FIG. 15 is a flowchart illustrating a flow of processing at the time of learning (operation of performing inference online during imaging) performed by the information processing apparatus 10 according to the first embodiment of the present disclosure.

FIG. 16 is a flowchart illustrating a flow of processing at the time of learning (operation of reading a stored image and performing learning) performed by the information processing apparatus 10 according to the first embodiment of the present disclosure.

FIG. 17 is a flowchart illustrating a flow of processing at the time of inference (operation of reading a stored image and performing inference) performed by the information processing apparatus 10 according to the first embodiment of the present disclosure.

FIG. 18 is a flowchart illustrating a flow of an operation relating to learning performed by the information processing apparatus 10 according to a second embodiment of the present disclosure (in a case where the protection target is specified by a user).

FIG. 19 is a flowchart illustrating a flow of an operation relating to learning performed by the information processing apparatus 10 according to the second embodiment of the present disclosure (in a case where the protection target is specified by information set in advance).

FIG. 20 is a diagram for describing a first modification.

FIG. 21 is a diagram illustrating a functional configuration example of an information processing apparatus 10 according to a second modification.

FIG. 22 is a diagram for describing the second modification.

FIG. 23 is a diagram for describing a third modification.

FIG. 24 is a block diagram illustrating a hardware configuration example of an information processing apparatus 900.

### DESCRIPTION OF EMBODIMENTS

Hereinafter, preferred embodiments of the present disclosure will be described in detail with reference to the accompanying drawings. Note that, in the present specification and drawings, components having substantially the same functional configuration are denoted by the same reference numerals to avoid the description from being redundant.

Note that the description will be given in the following order.
0. Outline
1. Details of first embodiment
1.1. Functional configuration example of information processing apparatus
1.2. Operation example of information processing apparatus
2. Details of second embodiment
3. Various modifications
4. Hardware configuration example
5. Conclusion

### 0. Outline

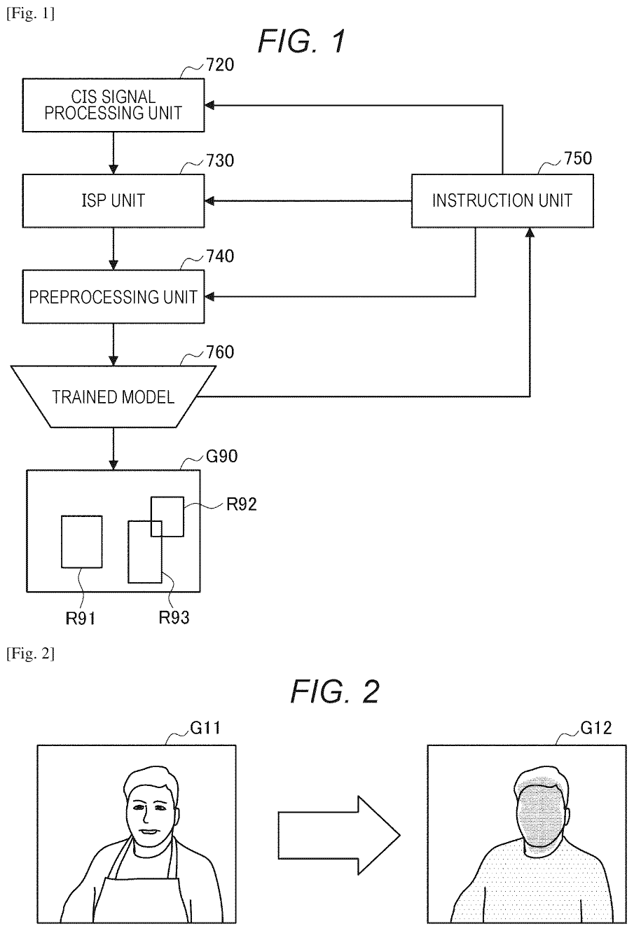

An outline of the embodiments of the present disclosure will be first described with reference to FIGS. 1 to 4. First, a typical recognition system will be described with reference to FIG. 1.

FIG. 1 is a diagram for describing the typical recognition system. As illustrated in FIG. 1, the typical recognition system includes a CIS signal processing unit 720, an ISP unit 730, a preprocessing unit 740, an instruction unit 750, and a trained model 760. Note that the CIS stands for a complementary metal oxide semiconductor (CMOS) image sensor, but the type of the image sensor is not particularly limited.

The CIS signal processing unit 720 performs various types of signal processing (hereinafter, also referred to “CIS signal processing”) on a signal input from the image sensor. As an example, the CIS signal processing unit 720 controls exposure time of the image sensor.

The ISP unit 730 performs various types of image signal processing (hereinafter, also referred to as “ISP processing”) on an image signal obtained as a result of the signal processing performed by the CIS signal processing unit 720. As an example, the ISP unit 730 removes noise from the image signal. The preprocessing unit 740 performs preprocessing on an image obtained as a result of the image signal processing performed by the ISP unit 730.

The trained model 760 is a model generated as a result of learning, and performs recognition on the basis of an image G90 obtained as a result of the processing performed by the preprocessing unit 740. For example, the trained model 760 includes a trained deep neural network (DNN).

More specifically, the trained model 760 includes a convolution neural network (CNN), and performs object detection based on the image G90 as an example of the recognition based on the image G90. FIG. 1 illustrates an example where the trained model 760 recognizes positions of object areas R91 to R93 each surrounding a corresponding object from the image G90 and a class to which each object belongs as an example of the object detection based on the image G90.

Here, it is assumed that the instruction unit 750 instructs the CIS signal processing unit 720 to increase the exposure time of the image sensor. In such a case, there is a possibility that the CIS signal processing unit 720 may increase the exposure time of the image sensor in accordance with the instruction. It is, however, assumed that the amount of noise contained in the image G90 increases due to the increase in the exposure time, and the accuracy of object detection decreases.

At this time, when recognizing that the amount of noise increases and the accuracy of object detection decreases, the trained model 760 instructs the ISP unit 730 to prioritize long exposure time while increasing the strength of noise reduction from the image signal. The ISP unit 730 increases the strength of noise reduction from the image signal in accordance with the instruction. As a result, a bright image reduced in noise is input to the trained model 760, thereby increasing the accuracy of object detection performed by the trained model 760.

### (Increase in Recognition Accuracy and Privacy Protection)

As described above, there is a technique of controlling the image signal processing performed by the ISP unit 730 on the basis of the recognition result from the trained model 760. For example, it is possible to implement the control of the image signal processing performed by the ISP unit 730 by controlling a parameter used by the ISP unit 730 for its operation. This allows an increase in accuracy of recognition performed by the trained model 760.

Similarly, the signal processing performed by the CIS signal processing unit 720 can also be controlled on the basis of the recognition result from the trained model 760. For example, it is possible to implement the control of the signal processing by controlling a parameter used by the CIS signal processing unit 720 for its operation. This allows an increase in accuracy of recognition performed by the trained model 760.

Proposed herein is mainly a technique enabling the generation of an image that allows an increase in accuracy of recognition performed by the trained model 760 and an image suitable for protecting the privacy of a person by utilizing the CIS signal processing control and the ISP processing control described above.

### (Resistance to Adversarial Attacks)

Moreover, damage caused by adversarial attacks has been recently reported. The adversarial attacks may mean that a third party extracts a recognition result from a model in an unauthorized manner. An image suitable for protecting the privacy of a person may also be an image resistant to such adversarial attacks.

### (Specification of Protection Target)

Furthermore, the number of types of features of a person who can be the protection target are not limited to one. That is, there may be a plurality of types of features of a person who can be the protection target. Hereinafter, examples of the feature of a person who can be the protection target will be described with reference to FIGS. 2 to 4. Note that, in the following description, the feature of a person is also referred to as “privacy information”.

FIG. 2 is a diagram for describing a first example of the privacy information that can be the protection target. With reference to FIG. 2, an image G11 in which a body of a person appears is illustrated. The body of the person may include a face and a torso (including a torso with clothes worn), and the like. Here, the body of the person appearing in the image G11 is high in clarity. It is therefore easy to recognize who the person appearing in the image G11 is from the image G11. As an example, who the person appearing in the image G11 is corresponds to the privacy information and can be the protection target.

Furthermore, with reference to FIG. 2, an image G12 generated on the basis of the image G11 is illustrated. The body of the person appearing in the image G12 is reduced in clarity. It is therefore difficult to recognize who the person appearing in the image G12 is from the image G12. Such an image G12 that makes it difficult to recognize who the person is corresponds to an example of an image suitable for protecting the privacy of a person.

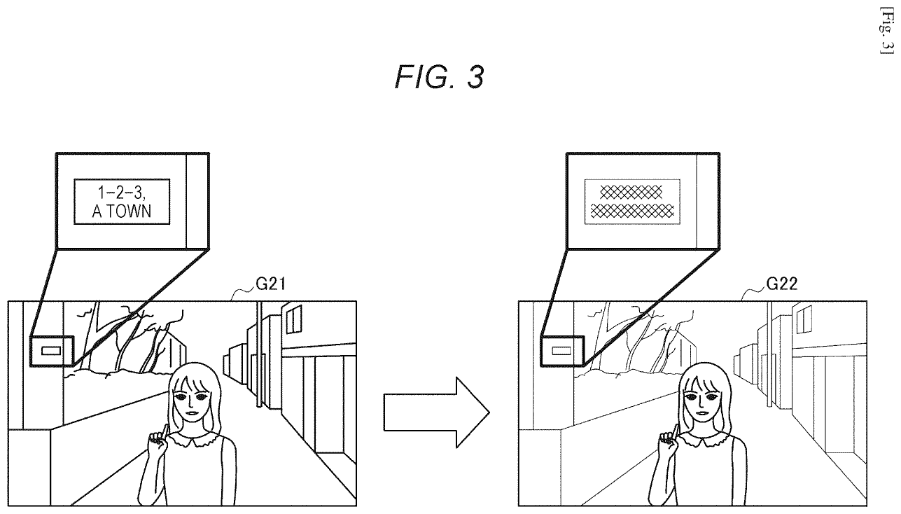

FIG. 3 is a diagram for describing a second example of the privacy information that can be the protection target. With reference to FIG. 3, an image G21 in which a body of a person and a background of the person appear is illustrated. Here, in the background of the person appearing in the image G21, character information “1-2-3, A town” indicating a place where the person is present is high in clarity. It is therefore easy to recognize the place where the person appearing in the image G21 is present from the image G21. As an example, the place where the person appearing in the image G21 is present corresponds to the privacy information and can be the protection target.

Furthermore, with reference to FIG. 3, an image G22 generated on the basis of the image G21 is illustrated. In the background of the person appearing in the image G22, the character information “1-2-3, A town” indicating the place where the person is present is low in clarity. It is therefore difficult to recognize the place where the person appearing in the image G22 is present from the image G22. Such an image G22 that makes it difficult to identify the place where the person is present corresponds to an example of the image suitable for protecting the privacy of a person.

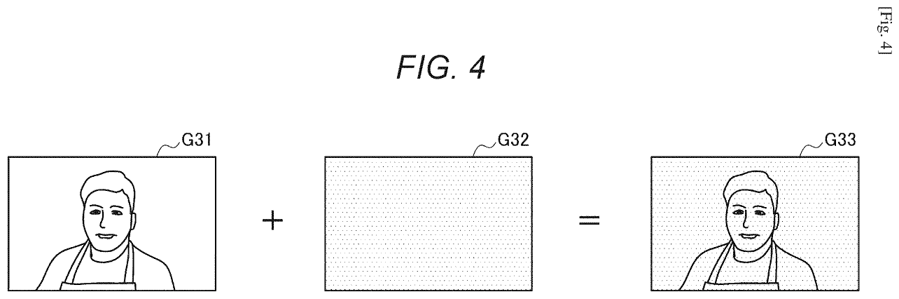

FIG. 4 is a diagram for describing a third example of the privacy information that can be the protection target. With reference to FIG. 4, an image G31 in which a body of a person appears is illustrated. Here, the body of the person appearing in the image G31 is high in clarity. It is therefore easy to recognize who the person appearing in the image G31 is from the image G31. As an example, who the person appearing in the image G31 is corresponds to the privacy information and can be the protection target.

Furthermore, with reference to FIG. 4, a noise image G32 is illustrated. Then, a composite image G33 obtained as a result of superimposing the image G31 and the noise image G32 on top of one another is illustrated. Noise contained in the composite image G33 is very small, but the noise prevents the person appearing in the composite image G33 from being recognized. Such a composite image G33 that prevents the person from being recognized corresponds to an example of the image suitable for protecting the privacy of a person.

As described with reference to FIGS. 2 to 4, examples of the protection target include who a person is, a place where the person is present, and the like. Examples of the protection target further include gender and age of the person. Then, there is also a possibility that it is desired to protect a specific feature among a plurality of types of features. Therefore, learning to reduce the accuracy of recognition of a specific protection target is also proposed herein.

### (Increase in Accuracy of Recognition Only for Specific Recognizer)

Furthermore, as described above, there is known a technique of disabling a recognizer to perform recognition only in a case where a specific device is used (for example, NPL 2 and the like). In a case where the specific device is not used (that is, in many cases), such a recognizer, however, can perform recognition.

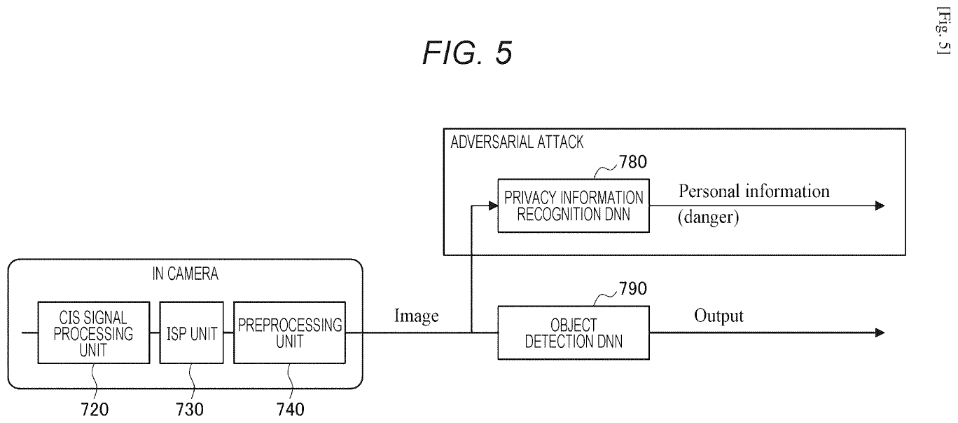

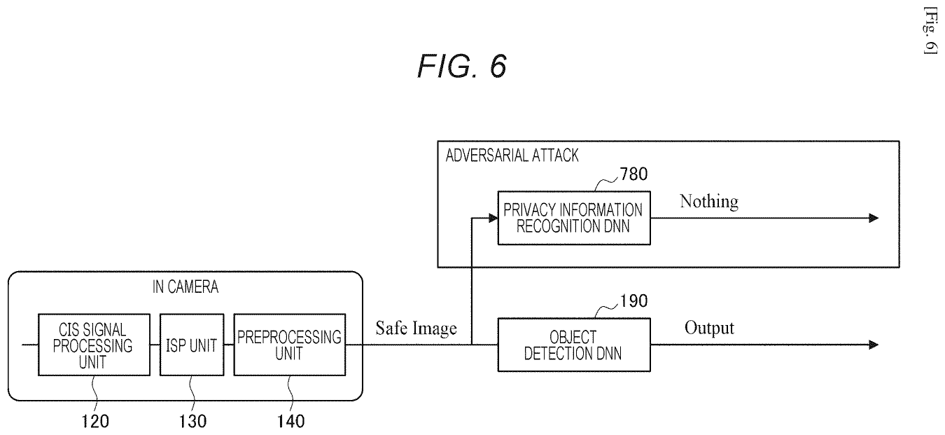

A technique of generating an image that increases the accuracy of recognition performed by a specific recognizer and an image that reduces the accuracy of recognition performed by a recognizer (hereinafter, referred to as general recognizer) other than the specific recognizer is also proposed herein. Hereinafter, an example where the recognizer that increases the accuracy of recognition is limited to the specific recognizer will be described with reference to FIGS. 5 and 6.

FIG. 5 is a diagram for describing an example of image generation according to a comparative example. With reference to FIG. 5, the CIS signal processing unit 720, the ISP unit 730, and the preprocessing unit 740 are present inside a camera. Then, an image processed and output by the CIS signal processing unit 720, the ISP unit 730, and the preprocessing unit 740 is input from the camera to an object detection DNN 790.

The object detection DNN 790 is an example of the specific recognizer, and performs object detection on the basis of the image output from the camera. For example, the object detection DNN 790 and the camera are incorporated into the same terminal, and the object detection DNN 790 performs an object detection task in an application. Therefore, the object detection DNN 790 is typically a specific recognizer manufactured by the same manufacturer as the manufacturer of the camera.

Here, in the comparative example, the image output from the camera is a clear image that is not suitable for privacy protection. Therefore, a normal object detection result is output from the object detection DNN 790.

A privacy information recognition DNN 780 is an example of the general recognizer, and recognizes privacy information of a person appearing in the image output from the camera. Typically, the privacy information recognition DNN 780 is a general recognizer manufactured by a manufacturer different from the manufacturer of the camera. For example, there is also a possibility that a third party inputs the image output from the camera to the privacy information recognition DNN 780, and makes an “adversarial attack” to extract privacy information from the privacy information recognition DNN 780 in an unauthorized manner.

As described above, in the comparative example, the image output from the camera is a clear image that is not suitable for privacy protection. The privacy information of the person appearing in the image is therefore output from the privacy information recognition DNN 780, and there is a risk of invasion of the privacy of the person appearing in the image.

FIG. 6 is a diagram for describing an example of image generation according to the embodiments of the present disclosure. With reference to FIG. 6, a CIS signal processing unit 120, an ISP unit 130, and a preprocessing unit 140 are present inside a camera. Then, an image processed and output by the CIS signal processing unit 120, the ISP unit 130, and the preprocessing unit 140 is input from the camera to an object detection DNN 190.

Note that, in the embodiments of the present disclosure, unlike the comparative example, a parameter of at least one of the CIS signal processing unit 120, the ISP unit 130, or the preprocessing unit 140 has been updated at the time of learning so as to reduce the accuracy of recognition performed by the privacy information recognition DNN 780 and to increase the accuracy of recognition performed by the object detection DNN 190. Therefore, the image output from the camera is an unclear image (that is, a safe image) suitable for privacy protection.

The object detection DNN 190 is an example of the specific recognizer corresponding to the object detection DNN 790 (FIG. 5) according to the comparative example, and performs object detection on the basis of the image output from the camera. For example, the object detection DNN 190 and the camera are incorporated into the same terminal, and the object detection DNN 190 performs an object detection task in an application. Therefore, the object detection DNN 190 is typically a specific recognizer manufactured by the same manufacturer as the manufacturer of the camera.

Here, in the embodiments of the present disclosure, since a parameter has been updated at the time of learning so as to increase the accuracy of recognition performed by the object detection DNN 190, a normal object detection result is output from the object detection DNN 790 in a manner similar to the comparative example.

On the other hand, in the embodiments of the present disclosure, the image output from the camera is an unclear image suitable for privacy protection. Therefore, according to the embodiments of the present disclosure, the privacy information of the person appearing in the image is not output from the privacy information recognition DNN 780, and it is possible to reduce the possibility of invasion of the privacy of the person appearing in the image.

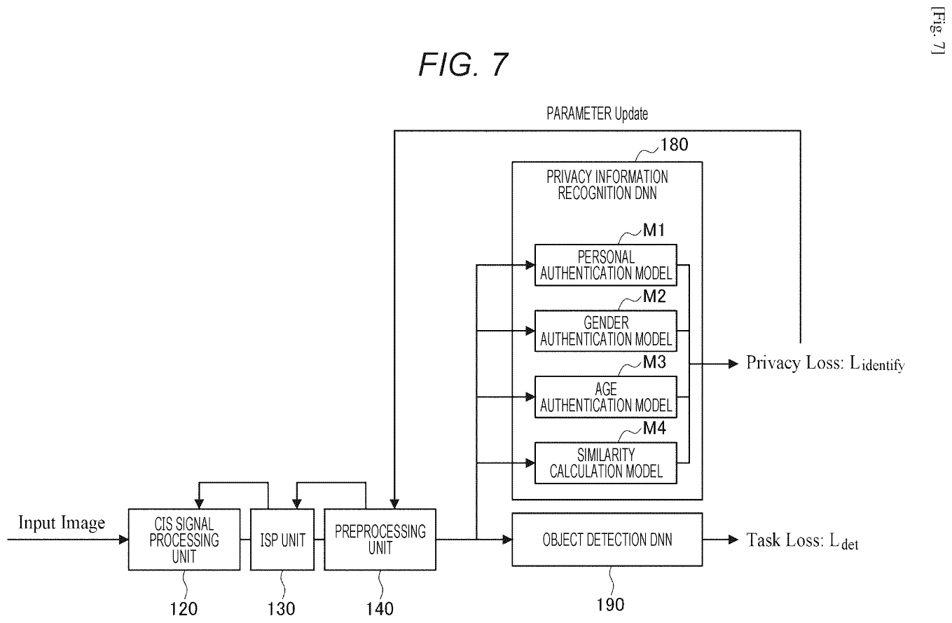

As in this example, according to the embodiments of the present disclosure, it is possible to generate an image that increases the accuracy of recognition performed by the specific recognizer and an image that reduces the accuracy of recognition performed by another recognizer (for example, the general recognizer). Note that, according to the embodiments of the present disclosure, it is also possible to generate an image that increases the accuracy of recognition in a specific scene or a specific use case and an image that reduces the accuracy of recognition in another scene or another use case. That is, the embodiments of the present disclosure are applicable to uses other than the use of preventing adversarial attacks. The following description will be given with the object detection DNN 190 as an example of the specific recognizer, and the privacy information recognition DNN 180 (FIG. 7) as an example of the general recognizer.

### (Devising of Effective Use of Loss in Learning)

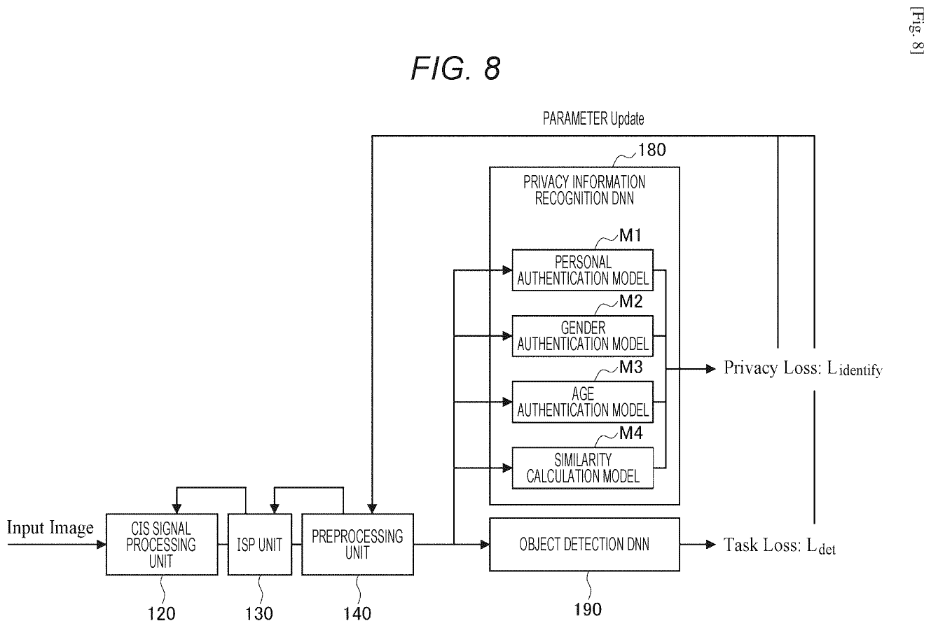

In the embodiments of the present disclosure, in order to generate an image that increases the accuracy of recognition performed by the object detection DNN 190 and an image that reduces the accuracy of recognition performed by the privacy information recognition DNN 180 (FIG. 7), effective use of a loss in learning is devised. Such devising of effective use of loss in learning will be described with reference to FIGS. 7 and 8.

FIG. 7 is a diagram for describing a first example of the loss used in learning. As illustrated in FIG. 7, in the embodiments of the present disclosure, it is mainly assumed that the privacy information recognition DNN 180 includes a personal authentication model M1, a gender authentication model M2, an age authentication model M3, and a similarity calculation model M4 as examples of a plurality of models. The number and types of models included in the privacy information recognition DNN 180, however, are not limited to such examples.

At the time of learning, an image processed and output by the CIS signal processing unit 120, the ISP unit 130, and the preprocessing unit 140 is input to both the privacy information recognition DNN 180 and the object detection DNN 190. At least one (hereinafter, also referred to as “selected model”) of the personal authentication model M1, the gender authentication model M2, the age authentication model M3, or the similarity calculation model M4 is selected, and the selected model performs recognition and outputs a recognition result.

Then, a first loss (hereinafter, also referred to as “privacy loss”) L_{identify} is calculated on the basis of a recognition score output from the selected model. At this time, L_{identify} is calculated to be smaller as the recognition score output from the selected model is lower. Note that, in the example illustrated in FIG. 7, it is mainly assumed that L based on a recognition score output from the privacy information recognition DNN 180 according to the embodiments of the present disclosure is used. However, instead of L_{identify}, a loss (for example, the reciprocal of the loss, or the like) based on a recognition result output from the general recognizer (such as a classifier or an object detector) other than the privacy information recognition DNN 180 may be used. By doing so, it is possible to prevent adversarial attacks made on the general recognizer.

The CIS signal processing unit 120, the ISP unit 130, and the preprocessing unit 140 have their respective parameters set therein. Then, an error based on L_{identify} is passed backward according to backpropagation to sequentially update the respective parameters of the preprocessing unit 140, the ISP unit 130, and the CIS signal processing unit 120.

Note that, here, it is mainly assumed that all the parameters of the preprocessing unit 140, the ISP unit 130, and the CIS signal processing unit 120 are updated. However, only some parameters of the preprocessing unit 140, the ISP unit 130, and the CIS signal processing unit 120 may be updated, and the order of parameter updates is not particularly limited (however, the ISP unit 130 is located in a stage following the CIS signal processing unit 120).

As described above, L_{identify} is considered as the loss, and learning based on the loss is performed, so that it is possible to perform learning to reduce the accuracy of recognition performed by the selected model (that is, learning to reduce the accuracy of recognition of the protection target). Then, an image suitable for privacy protection is generated by the CIS signal processing unit 120, the ISP unit 130, and the preprocessing unit 140 on the basis of the parameters obtained as a result of such learning.

FIG. 8 is a diagram for describing a second example of the loss used in learning. In a manner similar to the first example of the loss used in learning described with reference to FIG. 7, at the time of learning, an image processed and output by the CIS signal processing unit 120, the ISP unit 130, and the preprocessing unit 140 is input to both the privacy information recognition DNN 180 and the object detection DNN 190. In a manner similar to the first example of the loss used in learning, L_{identify} is calculated. Note that, in a manner similar to the example illustrated in FIG. 7, a loss based on the recognition result output from the general recognizer may be used instead of L_{identify}.

In the second example of the loss used in learning, a second loss (hereinafter, also referred to as “task loss”) L_{det} is calculated on the basis of the object detection result output from the object detection DNN 190. At this time, L_{det} is calculated to be smaller as the accuracy of recognition performed by the object detection DNN 190 is higher. Then, a loss based on L_{identify} and L_{det} is calculated.

An error based on the loss is passed backward according to backpropagation to sequentially update the respective parameters of the preprocessing unit 140, the ISP unit 130, and the CIS signal processing unit 120.

Note that, also in the second example of the loss used in learning, it is mainly assumed that all the parameters of the preprocessing unit 140, the ISP unit 130, and the CIS signal processing unit 120 are updated. In a manner similar to the first example of the loss used in learning, however, only some parameters of the preprocessing unit 140, the ISP unit 130, and the CIS signal processing unit 120 may be updated.

As described above, the loss is calculated on the basis of L_{identify} and L_{det}, and learning based on the loss is performed, so that it is possible to perform learning to reduce the accuracy of recognition performed by the selected model and learning to increase the accuracy of the object detection DNN 190. Then, the CIS signal processing unit 120, the ISP unit 130, and the preprocessing unit 140 generate an image suitable for privacy protection and an image that suppresses a reduction in accuracy of the task on the basis of the parameters obtained as a result of such learning.

In the following description, as described with reference to FIG. 8, it is mainly assumed that the loss based on L_{identify} and L_{det} is used for updating the parameters. As described with reference to FIG. 7, L_{identify} however, may be used as the loss to update the parameters without considering L_{det}.

The above is the outline of the embodiments of the present disclosure.

### 1. Details of First Embodiment

Next, the first embodiment of the present disclosure will be described in detail.

### (1.1. Functional Configuration Example of Information Processing Apparatus)

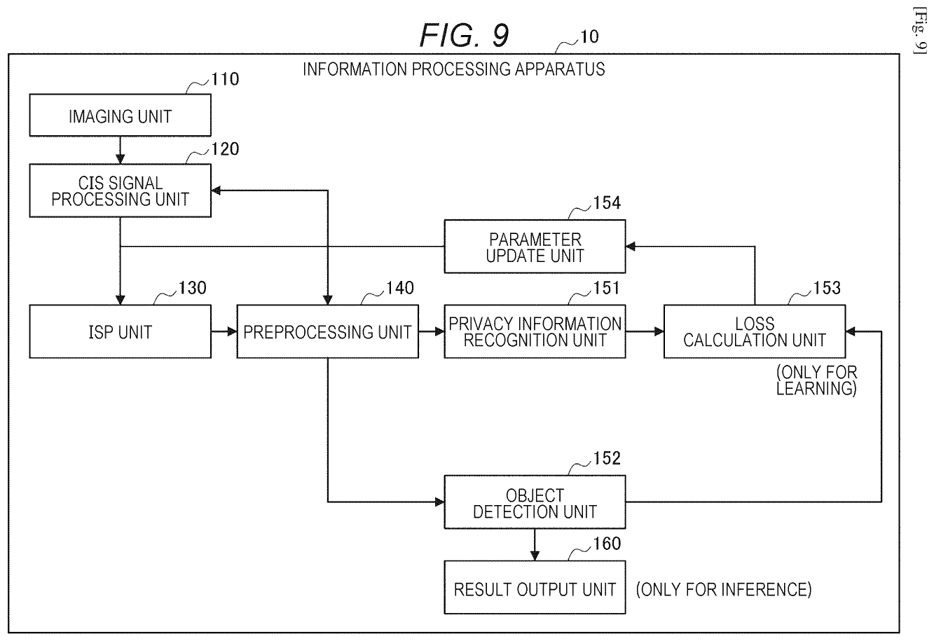

Next, with reference mainly to FIG. 9, a functional configuration example of an information processing apparatus 10 according to the first embodiment of the present disclosure will be described.

FIG. 9 is a diagram illustrating a functional configuration example of the information processing apparatus 10 according to the first embodiment of the present disclosure. As illustrated in FIG. 9, the information processing apparatus 10 according to the first embodiment of the present disclosure includes an imaging unit 110, a control unit (not illustrated), a storage unit (not illustrated), and a result output unit 160.

The control unit (not illustrated) may include one or a plurality of central processing units (CPUs), for example. In a case where the control unit (not illustrated) includes a processor such as a CPU, the processor may include an electronic circuit. The control unit (not illustrated) can be implemented by a program executed by the processor.

The control unit (not illustrated) includes the CIS signal processing unit 120, the ISP unit 130, the preprocessing unit 140, a privacy information recognition unit 151, an object detection unit 152, a loss calculation unit 153, and a parameter update unit 154.

The storage unit (not illustrated) is a recording medium that includes a memory, and stores a program to be executed by the control unit (not illustrated) and data necessary for executing the program. Furthermore, the storage unit (not illustrated) temporarily stores data for calculation performed by the control unit (not illustrated). The storage unit (not illustrated) includes a magnetic storage device, a semiconductor storage device, an optical storage device, a magneto-optical storage device, or the like.

### (Imaging Unit 110)

The imaging unit 110 obtains a signal by causing an image sensor to capture an image of an imaging range determined in accordance with the position and orientation of the imaging unit 110 in the real space, on the basis of a predetermined imaging start operation input by the user. The imaging unit 110 outputs the signal obtained by capturing the image of the imaging range to the CIS signal processing unit 120.

### (CIS Signal Processing Unit 120)

The CIS signal processing unit 120 performs various types of signal processing (that is, CIS signal processing) on the signal input from the imaging unit 110. For example, the CIS signal processing unit 120 performs remosaicing processing, defect correction, control of the exposure time of the imaging unit 110, adjustment to the analog gain of the imaging unit 110, and the like on the signal input from the imaging unit 110.

Note that the CIS signal processing unit 120 has a parameter set therein. Then, the parameter is used in the remosaicing processing, the defect correction, the control of the exposure time of the imaging unit 110, and the adjustment to the analog gain of the imaging unit 110 on the signal input from the imaging unit 110.

Furthermore, in a case where the information processing apparatus 10 is adapted to the signal obtained as result of imaging performed by the imaging unit 110, the information processing apparatus 10 need not include the CIS signal processing unit 120. Moreover, also in a case where images are on the cloud, the information processing apparatus 10 need not include the ISP unit 130.

### (ISP Unit 130)

The ISP unit 130 performs various types of image signal processing on an image signal obtained as a result of the signal processing performed by the CIS signal processing unit 720. For example, the ISP unit 130 performs demosaicing processing, sharpening processing, noise reduction, resolution conversion, digital gain adjustment, tone mapping, color correction, color conversion, normalization processing, quantization, or the like on the image signal obtained as a result of the signal processing performed by the CIS signal processing unit 720.

Note that the ISP unit 130 has a parameter set therein. Then, the parameter is used in the demosaicing processing, the sharpening processing, the noise reduction, the resolution conversion, the digital gain adjustment, the tone mapping, the color correction, the color conversion, the normalization processing, and the quantization on the image signal obtained as a result of the image signal processing performed by the ISP unit 130.

Furthermore, in a case where the signal output from the imaging unit 110 is not RAW data, the information processing apparatus 10 need not include the ISP unit 130. Moreover, also in a case where images are on the cloud, the information processing apparatus 10 need not include the ISP unit 130.

### (Preprocessing Unit 140)

The preprocessing unit 140 performs preprocessing on an image obtained as a result of the image signal processing performed by the ISP unit 130. For example, the preprocessing unit 140 performs resizing processing, cropping processing, or the like on the image input from the ISP unit 130. Note that the preprocessing unit 140 has a parameter set therein. Then, the parameter is used in the resizing processing and the cropping processing on the image obtained as a result of preprocessing performed by the preprocessing unit 140.

### (Privacy Information Recognition Unit 151)

The privacy information recognition unit 151 includes a privacy information recognition DNN 180 (FIG. 8). The privacy information recognition unit 151 inputs the image output from the preprocessing unit 140 to the selected model that is at least one of the personal authentication model M1, the gender authentication model M2, the age authentication model M3, or the similarity calculation model M4 to obtain data output from the selected model as a recognition result. Note that, as described above, the number and types of models are not particularly limited.

### (Object Detection Unit 152)

The object detection unit 152 functions as an example of an acquisition unit that acquires the image obtained as a result of performing the processing relating to the signal output from the imaging unit 110 on the basis of the parameters obtained as a result of performing learning to reduce the accuracy of recognition of the protection target. Moreover, the object detection unit 152 functions as an example of a recognition unit that performs recognition based on the image.

More specifically, the object detection unit 152 includes the object detection DNN 190 (FIG. 8). The object detection unit 152 inputs the image output from the preprocessing unit 140 to the object detection DNN 190 to obtain data output from the object detection DNN 190 as an object detection result. For example, as an example of the object detection based on the image, the object detection unit 152 recognizes a position of an object area surrounding an object and a class to which the object belongs from the image. Note that the object detection is merely an example of the task. Therefore, another task may be performed instead of the object detection.

### (Loss Calculation Unit 153)

The loss calculation unit 153 is put into operation only at the time of learning. The loss calculation unit 153 calculates L_{identify} on the basis of the recognition score output from the selected model. For example, the loss calculation unit 153 calculates L_{identify} such that the lower the recognition score output from the selected model, the smaller L_{identify} becomes. Moreover, the loss calculation unit 153 calculates L_{det} such that the higher the accuracy of recognition performed by the object detection DNN 190, the smaller L_{det} becomes.

Then, the loss calculation unit 153 calculates a loss based on L_{identify} and L_{det} More specifically, the loss calculation unit 153 may calculate the loss by multiplying L_{identify} by a coefficient λ (where λ is a positive number) and adding up the multiplication result obtained by multiplying L_{identify} by the coefficient λ and L_{det}. When the loss is denoted as Loss, for example, Loss can be calculated by the following expression (1).

$$Loss = {L}_{de t} ( F ( x ) , y ) + λ {L}_{identify} ( G ( x ) ) \qquad ( 1 )$$

Here, x denotes an input image, F(x) denotes an object detection result, y denotes ground truth data of the object detection result, and L_{det} denotes a loss based on F(x) and y. For example, in a case where the object detection based on the input image is the position of the object area, L_{det} may be a mean squared error based on F(x) and y. Alternatively, in a case where the object detection based on the input image is the class to which the object belongs, L_{det} may be a cross entropy based on F(x) and y.

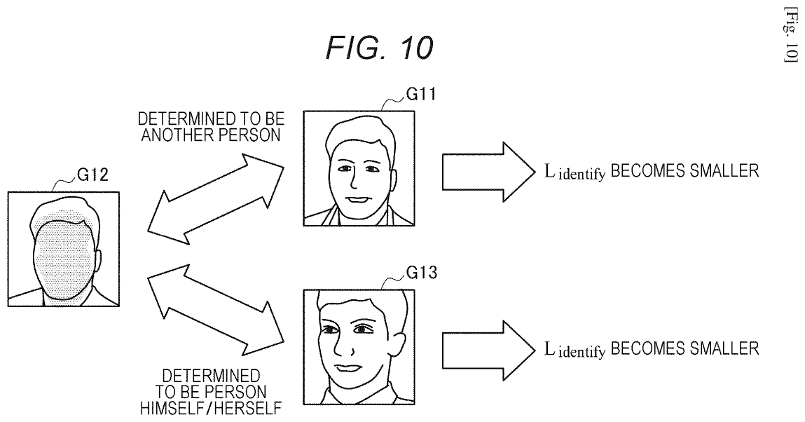

On the other hand, how to calculate L_{identify} differs in a manner that depends on which one of the personal authentication model M1, the gender authentication model M2, the age authentication model M3, and the similarity calculation model M4 is selected. In the following description, with reference to FIGS. 10 to 13, examples of calculation of L_{identify} that differs in a manner that depends on which one of the personal authentication model M1, the gender authentication model M2, the age authentication model M3, and the similarity calculation model M4 is selected will be described.

### (Personal Authentication Model M1)

FIG. 10 is a diagram for describing an example of calculation of L_{identify} in a case where the personal authentication model M1 is selected. With reference to FIG. 10, images G11 to G13 are illustrated.

The loss calculation unit 153 calculates L_{identify} on the basis of a difference between a result of recognition of a feature of a person based on the image G12 and a ground truth label of a feature of a person included in the image G11. Similarly, the loss calculation unit 153 calculates L_{identify} on the basis of a difference between the result of recognition of the feature of the person based on the image G12 and a ground truth label of a feature of a person included in the image G13. Then, the loss calculation unit 153 calculates L_{identify} such that the larger the difference between the result of recognition of the feature of the person (the degree of similarity of the person recognized from the image to the person himself/herself) and the ground truth label (ground truth value of the degree of similarity of the person recognized from the image to the person himself/herself), the smaller L_{identify} becomes. This allows the parameters to be updated so as to cause the recognition of the feature of the person to fail.

For example, the person recognized on the basis of the image G12 and the person appearing in the image G11 are the same person (that is, the person appearing in the image G12 is the person himself/herself). At this time, in a case where the personal authentication model M1 determines that the person recognized on the basis of the image G12 and the person appearing in the image G11 are not the same person (that is, the person appearing in the image G12 is another person), the loss calculation unit 153 decreases L_{identify}. This allows the parameters to be updated so as to cause the recognition of the individual to fail.

On the other hand, the person recognized on the basis of the image G12 is different from the person appearing in the image G13 (that is, the person appearing in the image G12 is another person). At this time, in a case where the personal authentication model M1 determines that the person recognized on the basis of the image G12 and the person appearing in the image G13 are the same person (that is, the person appearing in the image G12 is the person himself/herself), the loss calculation unit 153 decreases L_{identify}. This allows the parameters to be updated so as to cause the recognition of the individual to fail.

More specifically, with the recognition score from the personal authentication model M1 denoted as scoreᵢ(where 0<score<1), the higher the scoreᵢ, the higher the degree of similarity to the person himself/herself. Furthermore, the ground truth label is denoted as labelᵢ, a label indicating the person himself/herself is 1, and a label indicating another person is 0. At this time, L_{identify} can be calculated as indicated by the following expression (2).

$${L}_{identify} ( G ( x ) ) = \vert ( 1 - {label}_{i} ) - {score}_{i} \vert \qquad ( 2 )$$

Alternatively, the loss calculation unit 153 may calculate L_{identify} such that the smaller the difference between the result of recognition of the person based on the image G12 and the ground truth label of the person included in the image G13, the smaller L_{identify} becomes, and set a random value to the ground truth label. This also allows the parameters to be updated so as to cause the recognition of the person to fail.

Note that scoreᵢ may be calculated in any manner. As an example, scoreᵢ may be a result of authentication by facial recognition of the person appearing in the image G12. Alternatively, scoreᵢ may be a result of human body matching of the person appearing in the image G12. This allows the parameters to be updated such that the clothes worn by the person appearing in the image G12 also become unclear.

### (Gender Authentication Model M2)

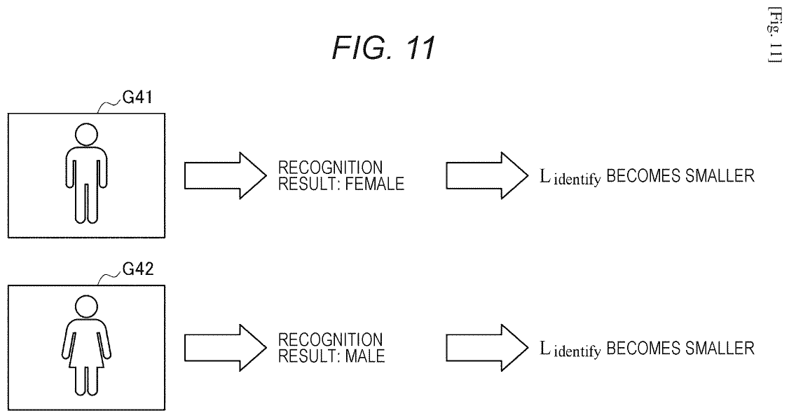

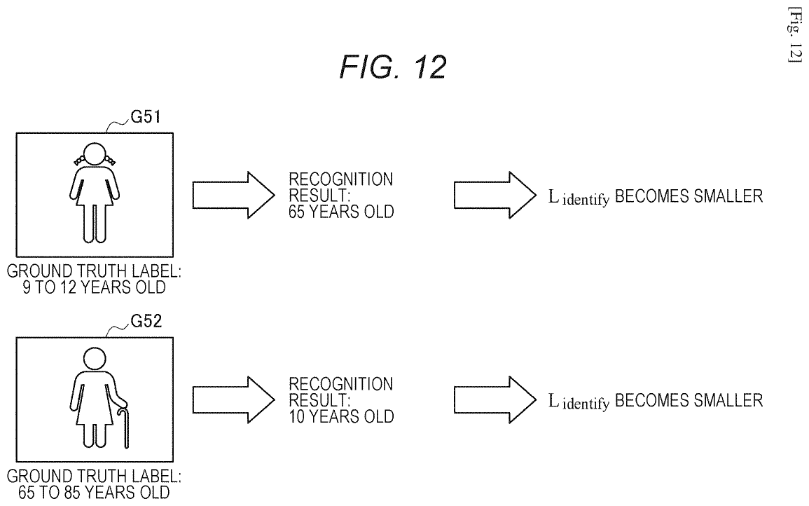

FIG. 11 is a diagram for describing an example of calculation of L_{identify} in a case where the gender authentication model M2 is selected. With reference to FIG. 11, images G41 and G42 are illustrated.

In the example illustrated in FIG. 11, the gender of a person appearing in the image G41 is male. Furthermore, a result of recognition of the gender of the person based on the image G41 is female. As described above, in a case where the gender authentication model M2 determines that the gender of the person appearing in the image G41 is different from the result of recognition of the gender of the person based on the image G41, the loss calculation unit 153 decreases L_{identify}. This allows the parameters to be updated so as to cause the recognition of the gender to fail.

On the other hand, the gender of a person appearing in the image G42 is female. Furthermore, a result of recognition of the gender of the person based on the image G42 is male. As described above, in a case where the gender authentication model M2 determines that the gender of the person appearing in the image G42 is different from the result of recognition of the gender of the person based on the image G42, the loss calculation unit 153 decreases L_{identify}. This allows the parameters to be updated so as to cause the recognition of the gender to fail.

More specifically, with the recognition score from the gender authentication model M2 denoted as scoreᵢ (where 0<score<1), the higher the scoreᵢ, the higher the degree of similarity to males. Furthermore, the ground truth label is denoted as labelᵢ, a label indicating males is 1, and a label indicating females is 0. At this time, L_{identify} if can be calculated as indicated by the above-described expression (2).

Alternatively, the loss calculation unit 153 may calculate L_{identify} such that the smaller a difference between the result of recognition of the gender of the person based on the image G41 and a ground truth label of the gender of the person included in the image G41, the smaller L_{identify} becomes, and set a random value to the ground truth label. Similarly, the loss calculation unit 153 may calculate L_{identify} such that the smaller a difference between the result of recognition of the gender of the person based on the image G42 and a ground truth label of the gender of the person included in the image G42, the smaller L_{identify} becomes, and set a random value to the ground truth label. This also allows the parameters to be updated so as to cause the recognition of the person's gender to fail.

### (Age Authentication Model M3)

FIG. 12 is a diagram for describing an example of calculation of L_{identify} in a case where the age authentication model M3 is selected. With reference to FIG. 12, images G51 and G52 are illustrated.

In the example illustrated in FIG. 12, the age of a person appearing in the image G51 is 9 to 12 years old. Furthermore, a result of recognition of the age of the person based on the image G51 is 65 years old. As described above, the loss calculation unit 153 decreases L_{identify} as a difference between the age of the person appearing in the image G51 and the result of recognition of the age of the person based on the image G51 determined by the age authentication model M3 increases. This allows the parameters to be updated so as to cause the recognition of the gender to fail.

On the other hand, the age of a person appearing in the image G52 is 65 to 85 years old. Furthermore, a result of recognition of the age of the person based on the image G52 is 10 years old. As described above, the loss calculation unit 153 decreases Lw, as a difference between the age of the person appearing in the image G52 and the result of recognition of the age of the person based on the image G52 determined by the age authentication model M3 increases.

This allows the parameters to be updated so as to cause the recognition of the gender to fail.

More specifically, the age estimated by the age authentication model M3 is denoted as scoreᵢ. Furthermore, a ground truth label indicating the actual age is denoted as labelᵢ and a minute constant for preventing division by zero is denoted as ε. At this time, L_{identify} can be calculated as indicated by the following expression (3).

$${L}_{identify} ( G ( x ) ) = 1 / ( \vert {label}_{i} - {score}_{i} \vert + ε ) \qquad ( 3 )$$

Alternatively, the loss calculation unit 153 may calculate L_{identify} such that the smaller the difference between the result of recognition the age of the person based on the image G51 and a ground truth label of the age of the person included in the image 51, the smaller L_{identify} becomes, and set a random value to the ground truth label. Similarly, the loss calculation unit 153 may calculate L_{identify} such that the smaller the difference between the result of recognition of the age of the person based on the image G52 and a ground truth label of the age of the person included in the image G52, the smaller L_{identify} becomes, and set a random value to the ground truth label. This also allows the parameters to be updated so as to cause the recognition of the person's age to fail.

### (Similarity Calculation Model M4)

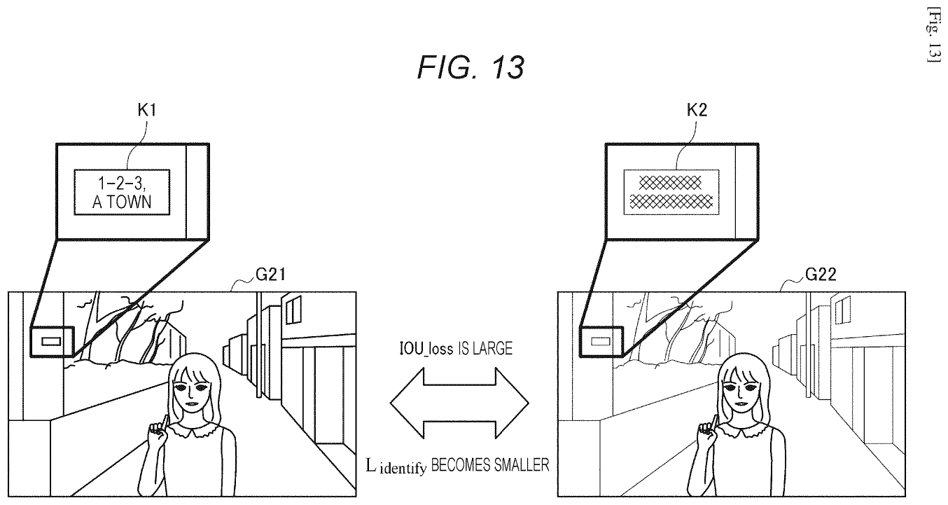

FIG. 13 is a diagram for describing an example of calculation of L_{identify} in a case where the similarity calculation model M4 is selected. With reference to FIG. 13, the images G21 and G22 are illustrated.

In the example illustrated in FIG. 13, a character string area K1 including a character string is present in the background appearing in the image G21. The character string includes one or a plurality of characters. Furthermore, a ground truth area K2 is prepared in advance. At this time, the loss calculation unit 153 decreases L_{identify} as an intersection over union (IOU) indicating a degree of coincidence between the character string area K1 and the ground truth area K2 determined by the similarity calculation model M4 decreases. This allows the parameters to be updated so as to cause the recognition of the character string to fail.

More specifically, the IOU indicating the degree of overlap between the character string area K1 and the ground truth area K2 determined by the similarity calculation model M4 is denoted as IOU_loss. At this time, L_{identify} can be calculated as indicated b the following expression (4).

$${L}_{identify} ( G ( x ) ) = 1 / IOU\_loss \qquad ( 4 )$$

Note that a value other than the IOU may be used as the degree of coincidence between the character string area K1 and the ground truth area K2. For example, as the degree of coincidence between the character string area K1 and the ground truth area K2, the reciprocal of the sum of absolute difference (SAD), the reciprocal of the sum of squared difference (SSD), the normalized cross-correlation (NCC), or the like may be used instead of the IOU.

Alternatively, there is also a possibility that the person appearing in the image G22 is allowed to remain clear. In such a case, instead of the degree of coincidence between the character string area K1 and the ground truth area K2, a degree of coincidence between an area other than the area surrounding the person (so-called a bounding box) and the ground truth area may be used.

Alternatively, instead of the degree of coincidence between the character string area K1 and the ground truth area K2, a degree of similarity between the input image input to the CIS signal processing unit 120 and the output image output from the ISP unit 130 may be used. At this time, the loss calculation unit 153 decreases L_{identify} as the degree of similarity between the input image and the output image determined by the similarity calculation model M4 decreases. This allows the parameters to be updated so as to reduce the degree of similarity between the images before and after input to the CIS signal processing unit 120 and the ISP unit 130.

More specifically, the input image input to the CIS signal processing unit 120 is denoted as x, the output image output from the ISP unit 130 is denoted as x′, and the degree of similarity between the input image x and the output image x′ determined by the similarity calculation model M4, that is, L_{identify} can be calculated as indicated by the following expression (5).

$${L}_{identify} ( G ( x ) ) = \vert 1 / ( x - x ’ ) \vert \qquad ( 5 )$$

Note that there is also a possibility that the person appearing in the image G22 is allowed to remain clear. In such a case, instead of the degree of similarity between the input image x and the output image x′, a degree of similarity between respective areas other than the area (bounding box) surrounding the person of the input image x and the output image x′ may be used.

### (Parameter Update Unit 154)

The parameter update unit 154 performs learning based on the loss calculated by the loss calculation unit 153. More specifically, the parameter update unit 154 passes an error based on the loss backward according to backpropagation to sequentially update the respective parameters of the preprocessing unit 140, the ISP unit 130, and the CIS signal processing unit 120. It is therefore possible to perform learning to reduce the accuracy of recognition performed by the selected model (that is, learning to reduce the accuracy of recognition of the protection target) and learning to increase the accuracy of the task of performing recognition based on the image.

Then, an image suitable for privacy protection is generated by the CIS signal processing unit 120, the ISP unit 130, and the preprocessing unit 140 on the basis of the parameters obtained as a result of such learning. Note that, as described above, only some parameters of the preprocessing unit 140, the ISP unit 130, and the CIS signal processing unit 120 may be updated, and the order of parameter updates is not particularly limited.

The type of the parameters updated by the parameter update unit 154 is not particularly limited. For example, the parameters updated by the parameter update unit 154 may include parameters used in at least one of remosaicing processing, defect correction, exposure time control, or analog gain adjustment. Such parameters can be used by the CIS signal processing unit 120.

Furthermore, the parameters updated by the parameter update unit 154 may include parameters used in at least one of demosaicing processing, sharpening processing, noise reduction, resolution conversion, digital gain adjustment, tone mapping, color correction, color conversion, normalization processing, or quantization. Such parameters can be used by the ISP unit 130.

The parameters updated by the parameter update unit 154 may include parameters used in at least one of resizing processing or cropping processing. Such parameters can be used by the preprocessing unit 140.

### (Result Output Unit 160)

The result output unit 160 outputs a detection result of an object detected by the object detection unit 152. For example, the result output unit 160 includes a display, and displays the detection result of the object detected by the object detection unit 152 on the display.

The functional configuration example of the information processing apparatus 10 according to the first embodiment of the present disclosure has been described above.

### (1.2. Operation Example of Information Processing Apparatus)

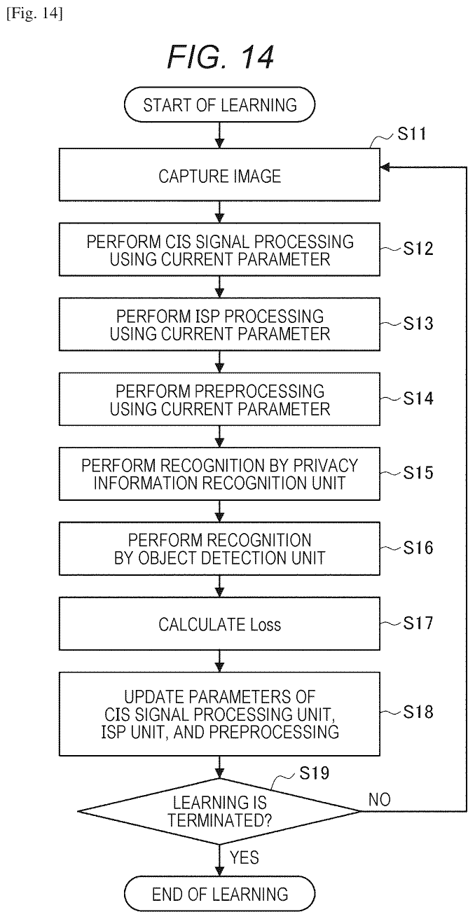

Next, with reference mainly to FIGS. 14 to 17, an operation example of the information processing apparatus 10 according to the first embodiment of the present disclosure will be described.

### (Learning Online During Imaging)

FIG. 14 is a flowchart illustrating a flow of processing at the time of learning (operation of performing learning online during imaging) performed by the information processing apparatus 10 according to the first embodiment of the present disclosure.

As illustrated in FIG. 14, the imaging unit 110 obtains a signal by causing the image sensor to capture an image of an imaging range determined in accordance with the position and orientation of the imaging unit 110 in the real space (S11). The CIS signal processing unit 120 performs CIS signal processing using the current parameter on the signal obtained by the imaging unit 110 (S12).

Subsequently, the ISP unit 130 performs ISP processing using the current parameter on an image signal obtained as a result of the CIS signal processing performed by the CIS signal processing unit 120 (S13). The preprocessing unit 140 performs preprocessing using the current parameter on an image obtained as a result of the ISP processing performed by the ISP unit 130 (S14). The privacy information recognition unit 151 performs recognition using the current parameter on the basis of an image obtained as a result of the preprocessed performed by the preprocessing unit 140 (S15). Furthermore, the object detection unit 152 performs recognition on the basis of the image obtained as a result of the preprocessing performed by the preprocessing unit 140 (S16).

Subsequently, the loss calculation unit 153 calculates L_{identify} such that the lower the recognition score output from the selected model, the smaller L_{identify} becomes. Moreover, the loss calculation unit 153 calculates L_{det} such that the higher the accuracy of recognition performed by the object detection DNN 190, the smaller L_{det} becomes. Then, the loss calculation unit 153 calculates a loss based on L_{identify} and L_{det} (S17).

The parameter update unit 154 passes an error based on the loss backward according to backpropagation to sequentially update the respective parameters of the preprocessing unit 140, the ISP unit 130, and the CIS signal processing unit 120 (S18). It is therefore possible to perform learning to reduce the accuracy of recognition performed by the selected model (that is, learning to reduce the accuracy of recognition of the protection target) and learning to increase the accuracy of the task of performing recognition based on the image.

In a case where the learning is not terminated (“NO” in S19), the information processing apparatus 10 cause the operation to proceed to S11. On the other hand, in a case where the learning is terminated (“YES” in S19), the information processing apparatus 10 terminates the learning. Note that learning termination conditions are not particularly limited. As an example, the information processing apparatus 10 may terminate the learning in a case where the number of parameter updates reaches a predetermined number of times.

### (Inference Online During Imaging)

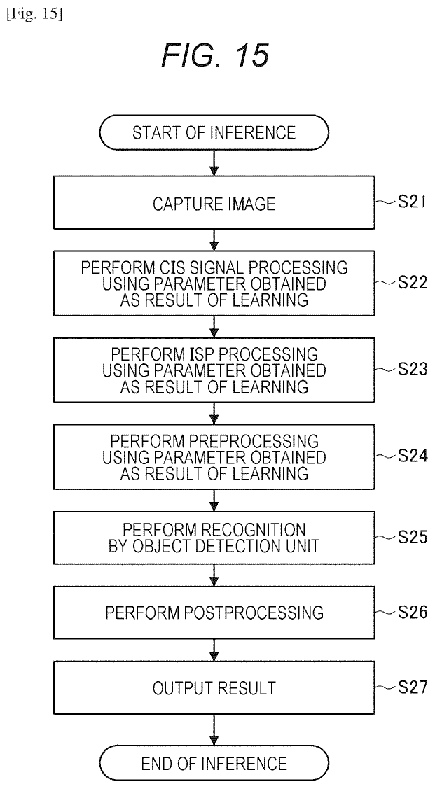

FIG. 15 is a flowchart illustrating a flow of processing at the time of inference (operation of performing inference online during imaging) performed by the information processing apparatus 10 according to the first embodiment of the present disclosure.

In a manner similar to the operation of performing learning online during imaging illustrated in FIG. 14, the imaging unit 110 obtains a signal by causing the image sensor to capture an image of an imaging range determined in accordance with the position and orientation of the imaging unit 110 in the real space (S21). The CIS signal processing unit 120 performs CIS signal processing using the parameter obtained as a result of the learning on the signal obtained by the imaging unit 110 (S22).

Subsequently, the ISP unit 130 performs ISP processing using the parameter obtained as a result of the learning on an image signal obtained as a result of the CIS signal processing performed by the CIS signal processing unit 120 (S23). The preprocessing unit 140 performs preprocessing using the parameter obtained as a result of the learning on an image obtained as a result of the ISP processing performed by the ISP unit 130 (S24). The object detection unit 152 performs recognition on the basis of the image obtained as a result of the preprocessing performed by the preprocessing unit 140 (S25). Then, the object detection unit 152 performs postprocessing (S26).

The result output unit 160 outputs a detection result of an object detected by the object detection unit 152 (S27). For example, the result output unit 160 includes a display, and displays the detection result of the object detected by the object detection unit 152 on the display.

### (Read Stored Image and Perform Learning)

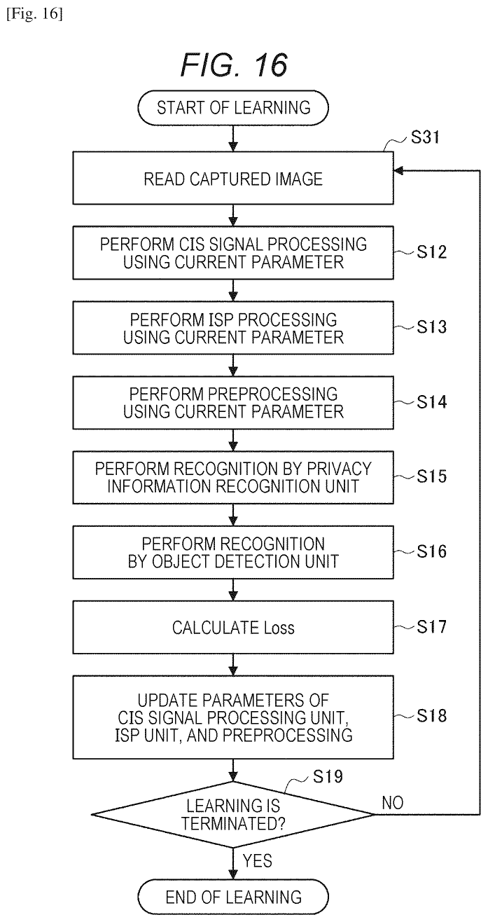

FIG. 16 is a flowchart illustrating a flow of processing at the time of learning (operation of reading a stored image and performing learning) performed by the information processing apparatus 10 according to the first embodiment of the present disclosure.

As illustrated in FIG. 16, an image stored in a predetermined memory is read (S31). Note that the predetermined memory may reside anywhere. Note that the predetermined memory may reside inside the information processing apparatus 10, may reside in a cloud server, may reside in a personal computer (PC), or may reside in a smartphone or another terminal.

S12 to S19 are almost identical to S12 to S19 illustrated in FIG. 14. Note that S12 can be performed in a case where the image read from the predetermined memory is RAW data not subjected to the CIS signal processing. Furthermore, S13 can be performed in a case where the image read from the predetermined memory is RAW data not subjected to the ISP processing.

### (Read Stored Image and Perform Inference)

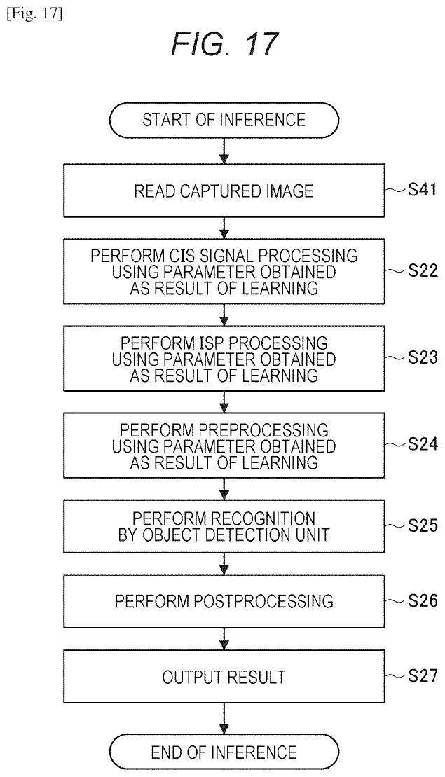

FIG. 17 is a flowchart illustrating a flow of processing at the time of inference (operation of reading a stored image and performing inference) performed by the information processing apparatus 10 according to the first embodiment of the present disclosure.

As illustrated in FIG. 17, an image stored in the predetermined memory is read (S41). Note that, in a manner similar to S31 illustrated in FIG. 16, the predetermined memory may reside anywhere. Note that, in a manner similar to the example illustrated in FIG. 16, S22 can be performed in a case where the image read from the predetermined memory is RAW data not subjected to the CIS signal processing. Furthermore, S23 can be performed in a case where the image read from the predetermined memory is RAW data not subjected to the ISP processing.

The first embodiment of the present disclosure has been described above in detail.

### 2. Details of Second Embodiment

Next, the second embodiment of the present disclosure will be described in detail.

### (2.1. Functional Configuration Example of Information Processing Apparatus)

An information processing apparatus according to the second embodiment of the present disclosure is almost identical to the functional configuration example of the information processing apparatus 10 according to the first embodiment of the present disclosure. Therefore, also in the second embodiment of the present disclosure, a functional configuration example of the information processing apparatus 10 according to the second embodiment of the present disclosure will be described with reference mainly to FIG. 9.

In the information processing apparatus 10 according to the first embodiment of the present disclosure, how the protection target is specified has not been mentioned. On the other hand, in the second embodiment of the present disclosure, the protection target is specified by the user or the information processing apparatus 10 (that is, the system) from a plurality of candidates for the protection target. More specifically, the protection target may be specified from the plurality of candidates by the user. Note that an operation unit (not illustrated) included in the information processing apparatus 10 may accept an operation from the user.

Alternatively, a priority may be associated with each of the plurality of candidates. At this time, the privacy information recognition unit 151 may specify the protection target from the plurality of candidates on the basis of the priority of each of the plurality of candidates. As an example, the privacy information recognition unit 151 may detect the highest priority among the priorities of the plurality of candidates and specify a candidate associated with the highest priority as the protection target from the plurality of candidates. For example, there are many users who do not want their body parts (for example, faces or the like) unique to individuals to be known, so that the highest priority may be associated with a candidate corresponding to who the person appearing in the image is.

Alternatively, the privacy information recognition unit 151 may specify the protection target from the plurality of candidates in accordance with the type of the task of performing recognition based on the image. Alternatively, the privacy information recognition unit 151 may specify the protection target from the plurality of candidates in accordance with the type of the application that performs the task. For example, in a case where the type of the application that performs the task is a social networking service (SNS), the user may allow his/her face to be known, but may consider that he/she does not want his/her location to be known. Therefore, in a case where the type of the application that performs the task is the SNS, the privacy information recognition unit 151 may specify the place where the person is present as the protection target. Alternatively, the privacy information recognition unit 151 may specify not only a part of the plurality of candidates but also all of the plurality of candidates as the protection target.

Note that the protection target is the feature of a person included in an image. Then, the feature of a person may include at least one of who the person is, the gender of the person, the age of the person, or the place where the person is present.

The functional configuration example of the information processing apparatus 10 according to the second embodiment of the present disclosure has been described above.

### (2.2. Operation Example of Information Processing Apparatus)

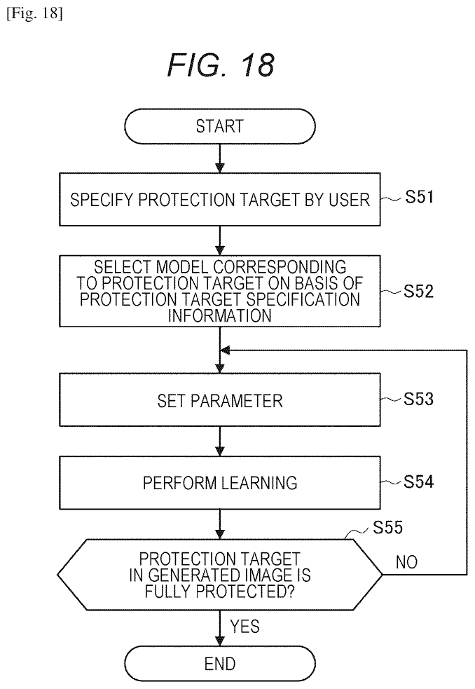

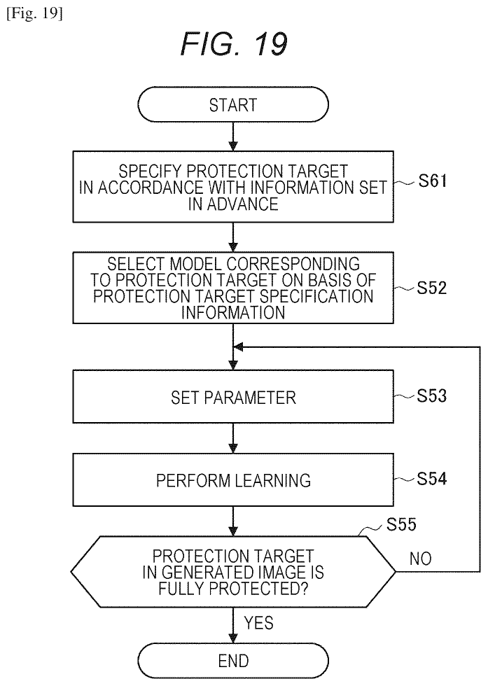

Next, with reference mainly to FIGS. 18 and 19, an operation example of the information processing apparatus 10 according to the second embodiment of the present disclosure will be described.

### (Specification of Protection Target by User)

FIG. 18 is a flowchart illustrating a flow of an operation relating to learning performed by the information processing apparatus 10 according to the second embodiment of the present disclosure (in a case where the protection target is specified by the user).

As illustrated in FIG. 18, the user specifies the protection target from the plurality of candidates (S51), and inputs protection target specification information for specifying the protection target. This causes the privacy information recognition unit 151 to select a model corresponding to the protection target on the basis of the protection target specification information (S52).

For example, in a case where who the person is specified as the protection target, the privacy information recognition unit 151 selects the personal authentication model M1 corresponding to the protection target. Similarly, in a case where the gender of the person is specified as the protection target, the privacy information recognition unit 151 selects the gender authentication model M2 corresponding to the protection target.

In a case where the age of the person is specified as the protection target, the privacy information recognition unit 151 selects the age authentication model M3 corresponding to the protection target. In a case where the place where the person is present is specified as the protection target, the privacy information recognition unit 151 selects the similarity calculation model M4 corresponding to the protection target. The parameter update unit 154 sets various parameters (S53). Examples of the various parameters include a learning rate, a coefficient λ of L_{identify} (expression (1) described above), and an optimization method.

Subsequently, in a manner similar to the first embodiment of the present disclosure, the loss calculation unit 153 calculates a loss based on L_{identify} and L_{det} and the parameter update unit 154 performs learning based on the loss calculated by the loss calculation unit 153 (S54). The parameter update unit 154 determines whether or not the protection target in the image generated by the CIS signal processing unit 120, the ISP unit 130, and the preprocessing unit 140 is fully protected (S55).

Note that the parameter update unit 154 may determine whether or not the protection target in the image generated by the CIS signal processing unit 120, the ISP unit 130, and the preprocessing unit 140 is fully protected on the basis of whether or not a score of personal authentication based on the image is greater than a threshold. In a case where the protection target in the generated image is not fully protected (“NO” in S55), the parameter update unit 154 cause the operation to proceed to S53.

Then, the parameters are reset (S53), and the operations after S54 are performed again. Note that examples of the resetting of the parameters include changing various parameters (for example, changing the learning rate, changing the coefficient λ, changing the optimization method, and the like). For example, changing the coefficient λ may be increasing the coefficient λ. As a result, it can be expected that the protection target is more strongly protected.

On the other hand, in a case where the protection target in the generated image is fully protected (“YES” in S55), the CIS signal processing unit 120 terminates the operation relating to learning.

### (Specification of Protection Target by Information Set in Advance)

FIG. 19 is a flowchart illustrating a flow of an operation relating to learning performed by the information processing apparatus 10 according to the second embodiment of the present disclosure (in a case where the protection target is specified by information set in advance).

As illustrated in FIG. 19, the privacy information recognition unit 151 specifies the protection target in accordance with the information set in advance (S61). Note that the information set in advance may be the priority associated with each of the plurality of candidates, the type of the task of performing recognition based on the image, the type of the application that performs the task, or the like. Note that S52 to S55 illustrated in FIG. 19 may be performed in a manner similar to S52 to S55 illustrated in FIG. 18.

The second embodiment of the present disclosure has been described above in detail.

### 3. Various Modifications

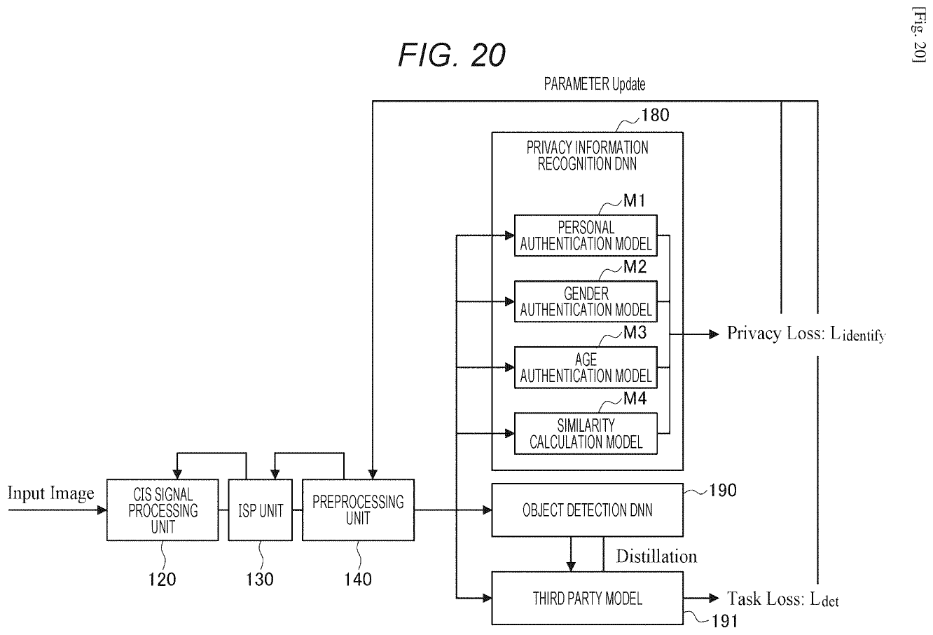

Next, with reference to FIGS. 20 to 23, various modifications of the information processing apparatus 10 according to the embodiment of the present disclosure will be described.

### (First Modification)

FIG. 20 is a diagram for describing a first modification. With reference to FIG. 20, in the first modification, a Third party model 191 is provided in addition to the privacy information recognition DNN 180 and the object detection DNN 190.

For example, the object detection DNN 190 may function as a teacher model, and the Third party model 191 may function as a student model to implement knowledge distillation. In such knowledge distillation, the object detection DNN 190 provides data acquired as a result of learning to the Third party model 191. For example, the data acquired as a result of learning may be a feature of each layer and the output result from the object detection DNN 190 obtained in accordance with the image output from the preprocessing unit 140.

The image output from the preprocessing unit 140 is input to the Third party model 191. Then, the Third party model 191 obtains the feature of each layer and the output result in accordance with the image.

The loss calculation unit 153 calculates L_{det} such that the feature of each layer obtained by the Third party model 191 approaches the feature of each layer obtained from the object detection DNN 190, and the output result obtained from the Third party model 191 approaches the output result obtained from the object detection DNN 190 (alternatively, both the output result obtained from the object detection DNN 190 and the ground truth data). L_{det} is used to update the parameters of the preprocessing unit 140, the ISP unit 130, and the CIS signal processing unit 120. Furthermore, the Third party model 191 can function as a recognition unit that performs recognition based on the image output from the preprocessing unit 140 at the time of inference.

The first modification has been described above.

### (Second Modification)

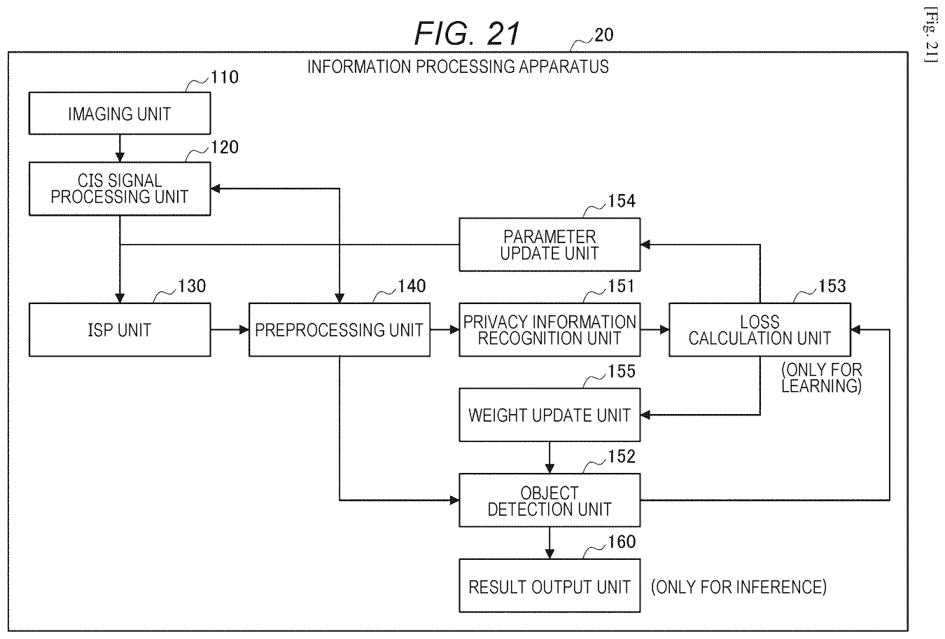

FIG. 21 is a diagram illustrating a functional configuration example of an information processing apparatus 20 according to a second modification. With reference to FIG. 21, the second modification is different from the first embodiment of the present disclosure mainly in that the information processing apparatus 20 includes a weight update unit 155. Therefore, in the second modification, the weight update unit 155 will be mainly described.

### (Weight Update Unit 155)

The weight update unit 155 performs learning to increase the accuracy of the task performed by the object detection DNN 190. Alternatively, the weight update unit 155 may perform learning to increase the accuracy of the task performed by the object detection DNN 190 and learning to reduce the accuracy of recognition of the protection target.

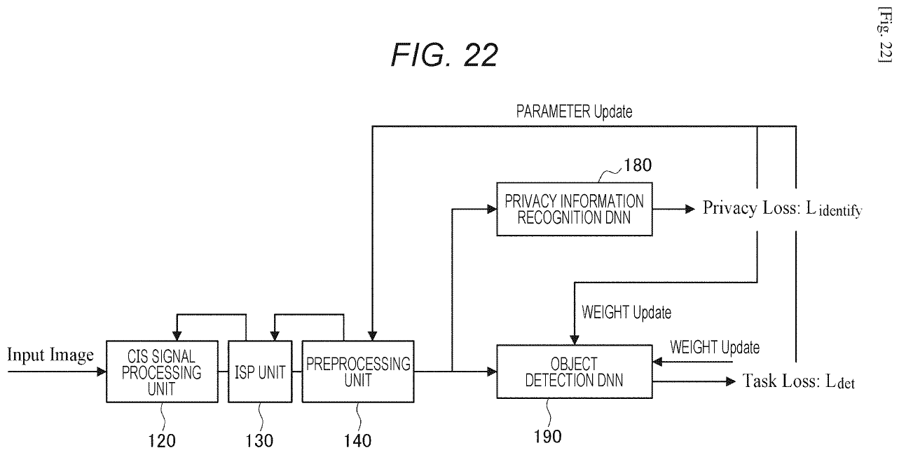

FIG. 22 is a diagram for describing the second modification. As illustrated in FIG. 22, the weight update unit 155 passes an error based on L_{det} backward according to backpropagation to update a weight of the object detection DNN 190. It is therefore expected that learning to further increase the accuracy of the task of performing recognition based on the image is performed.

Alternatively, the loss calculation unit 153 may calculate a loss on the basis of not only L_{det} but also L_{identify} and the parameter update unit 154 may pass an error based on the loss calculated by the loss calculation unit 153 backward according to backpropagation to update the weight of the object detection DNN 190. At this time, in order to further increase the accuracy of the task, a loss calculated by substituting a negative value for the coefficient λ in the above-described expression (1) may be used for updating the weight of the object detection DNN 190.

The second modification has been described above.

### (Third Modification)

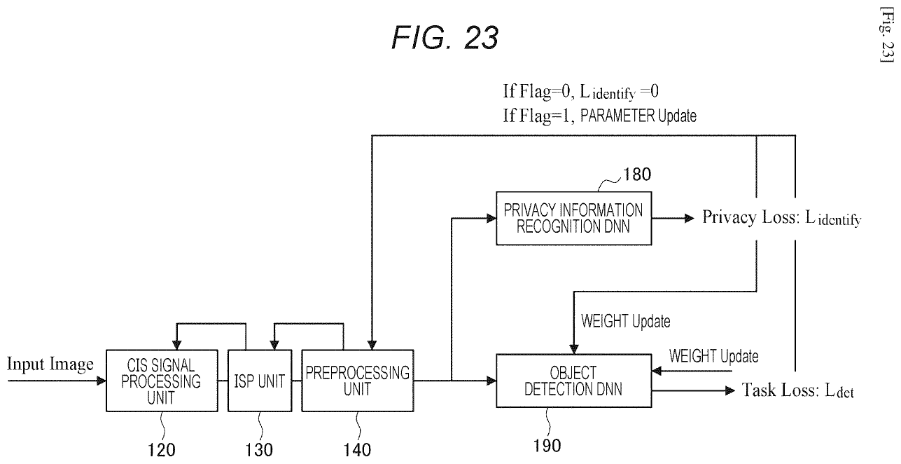

FIG. 23 is a diagram for describing a third modification. In the third modification, the parameter update unit 154 may perform learning to reduce the accuracy of recognition of the protection target on the basis of a fact that the image output from the preprocessing unit 140 satisfies a predetermined condition. On the other hand, the parameter update unit 154 need not perform learning to reduce the accuracy of recognition of the protection target on the basis of a fact that the image output from the preprocessing unit 140 does not satisfy the predetermined condition.

For example, in a case where no person is appearing in an image, it is not necessary to protect privacy, so that it may be desirable that the image output from the preprocessing unit 140 be not changed. Therefore, the predetermined condition may include a condition where a person is recognized from an image.

That is, as illustrated in FIG. 23, the parameter update unit 154 may initialize a flag to 1, and set the flag to 0 in a case where the condition where a person is recognized from an image is not satisfied. Then, in a case where the flag is set to 0, the parameter update unit 154 may set L_{identify} to 0 so as to prevent L_{identify} from affecting the loss.

The third modification has been described above.

### 4. Hardware Configuration Example

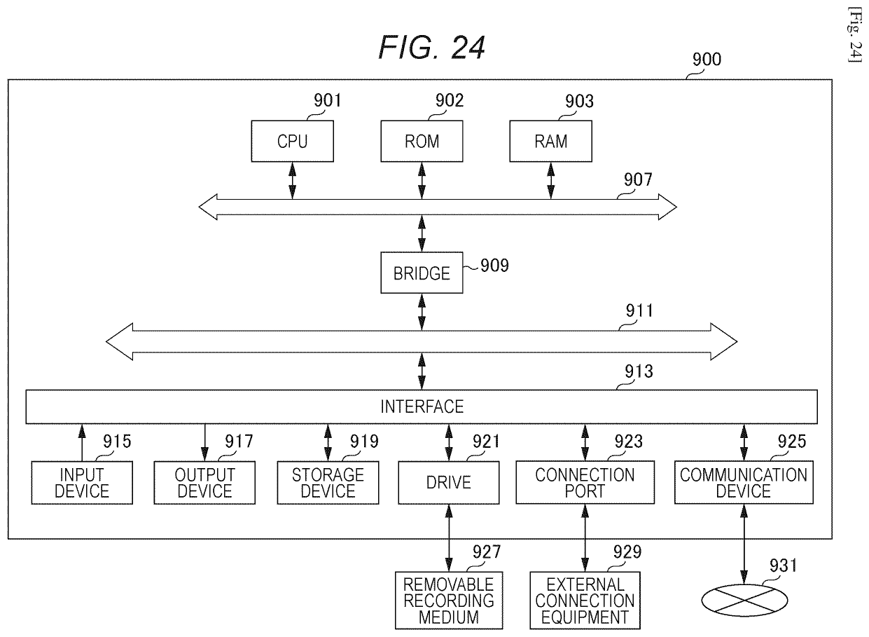

Next, a hardware configuration example of an information processing apparatus 900 as an example of the information processing apparatus 10 according to the embodiments of the present disclosure will be described with reference to FIG. 24. FIG. 24 is a block diagram illustrating the hardware configuration example of the information processing apparatus 900. Note that the information processing apparatus 10 does not necessarily have all of the hardware configurations illustrated in FIG. 24, and a part of the hardware configurations illustrated in FIG. 24 does not need to exist in the information processing apparatus 10.

As illustrated in FIG. 24, the information processing apparatus 900 includes a central processing unit (CPU) 901, a read only memory (ROM) 902, and a random access memory (RAM) 903. Furthermore, the information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may have a processing circuit called a digital-signal processor (DSP) or an application-specific integrated circuit (ASIC) instead of or in combination with the CPU 901.

The CPU 901 functions as an arithmetic processing device and a control device, and controls all or a part of operation in the information processing apparatus 900 in accordance with various programs recorded in the ROM 902, the RAM 903, the storage device 919, or a removable recording medium 927. The ROM 902 stores programs, calculation parameters and the like used by the CPU 901. The RAM 903 temporarily stores a program used in execution by the CPU 901, and parameters that change as appropriate during the execution, and the like. The CPU 901, the ROM 902, and the RAM 903 are mutually connected by the host bus 907 including an internal bus such as a CPU bus. Moreover, the host bus 907 is connected to the external bus 911 such as a peripheral component interconnect/interface (PCI) bus via the bridge 909.

The input device 915 is, for example, a device, such as a button, operated by the user. The input device 915 may include a mouse, a keyboard, a touch panel, a switch and a lever, or the like. Furthermore, the input device 915 may also include a microphone that detects voice of the user. The input device 915 may be, for example, a remote control device utilizing infrared light or other radio waves, or may be external connection equipment 929 such as a mobile phone adapted to the operation of the information processing apparatus 900. The input device 915 includes an input control circuit that generates and outputs an input signal to the CPU 901 on the basis of information input by the user. By operating the input device 915, the user inputs various kinds of data or gives an instruction to perform a processing operation, to the information processing apparatus 900. Furthermore, an imaging device 933 as described later can function as the input device by capturing an image of motion of a hand of the user, a finger of the user, or the like. At this time, a pointing position may be determined in accordance with the motion of the hand and the direction of the finger.

The output device 917 includes a device that can visually or audibly notify the user of acquired information. The output device 917 may be, for example, a display device such as a liquid crystal display (LCD) or an organic electro-luminescence (EL) display, an audio output device such as a speaker and headphones, or the like. Furthermore, the output device 917 may include a plasma display panel (PDP), a projector, a hologram, a printer device, or the like. The output device 917 outputs a result of processing performed by the information processing apparatus 900 as a video such a text or an image, or outputs the result as a sound such as voice or audio. Furthermore, the output device 917 may include a light or the like in order to brighten the surroundings.

The storage device 919 is a data storage device configured as an example of a storage unit of the information processing apparatus 900. The storage device 919 includes, for example, a magnetic storage device such as a hard disk drive (HDD), a semiconductor storage device, an optical storage device, a magneto-optical storage device, or the like. The storage device 919 stores programs executed by the CPU 901 and various kinds of data, various kinds of data acquired from the outside, and the like.

The drive 921 is a reader/writer for the removable recording medium 927, such as a magnetic disk, an optical disc, a magneto-optical disk, or a semiconductor memory, and is built in or externally attached to the information processing apparatus 900. The drive 921 reads information recorded in the mounted removable recording medium 927, and outputs to the RAM 903. Furthermore, the drive 921 writes records in the mounted removable recording medium 927.

The connection port 923 is a port for directly connecting equipment to the information processing apparatus 900.

The connection port 923 may be, for example, a universal serial bus (USB) port, an IEEE1394 port, a small computer system interface (SCSI) port, or the like. Furthermore, the connection port 923 may be an RS-232C port, an optical audio terminal, a high-definition multimedia interface (HDMI (registered trademark)) port, or the like. By connecting the external connection equipment 929 to the connection port 923, various kinds of data can be exchanged between the information processing apparatus 900 and the external connection equipment 929.

The communication device 925 is, for example, a communication interface including a communication device for connecting to a network 931, or the like. The communication device 925 may be, for example, a communication card for a wired or wireless local area network (LAN), Bluetooth (registered trademark), wireless USB (WUSB), or the like. Furthermore, the communication device 925 may be a router for optical communication, a router for asymmetric digital subscriber line (ADSL), a modem for various types of communication, or the like. For example, the communication device 925 transmits and receives signals and the like to and from the Internet and other communication equipment, by using a predetermined protocol such as TCP/IP. Furthermore, the network 931 connected to the communication device 925 is a network connected in a wired or wireless manner, and is, for example, the Internet, a home LAN, infrared communication, radio wave communication, satellite communication, or the like.

### 5. Conclusion

According to the first embodiment of the present disclosure, it is possible to generate an image that allows an increase in accuracy of recognition performed by the task and an image suitable for protecting the privacy of a person. The image suitable for protecting the privacy of a person may also be an image resistant to adversarial attacks.

Moreover, according to the first embodiment of the present disclosure, it is possible to generate an image that increases the accuracy of recognition performed by the specific recognizer and an image that reduces the accuracy of recognition performed by another recognizer (for example, the general recognizer).

Furthermore, according to the second embodiment of the present disclosure, in addition to the effect produced by the first embodiment of the present disclosure, it is possible to produce an effect of allowing learning to reduce the accuracy of recognition of a specific protection target to be performed.

The preferred embodiments of the present disclosure have been described above in detail with reference to the accompanying drawings, but the technical scope of the present disclosure is not limited to such examples. It is apparent that a person having ordinary knowledge in the technical field of the present disclosure can devise various change examples or modification examples within the scope of the technical idea described in the claims, and it will be naturally understood that they also belong to the technical scope of the present disclosure.

For example, the case where the imaging unit 110 is used as a sensor, and the image obtained by the imaging unit 110 is used as sensor data has been described above. Another sensor, however, may be used instead of the imaging unit 110. For example, a microphone may be used as the sensor. At this time, acoustic data obtained by the microphone may be used as the sensor data. Alternatively, a depth sensor may be used as the sensor. At this time, depth information obtained by the depth sensor may be used as the sensor data.

Furthermore, the effects described herein are merely exemplary or illustrative, and not restrictive. That is, the technology according to the present disclosure can produce other effects that are apparent to those skilled in the art from the description given herein, in addition to or instead of the above-described effects.

Note that the following configurations also fall within the technical scope of the present disclosure.
(1) An image generation apparatus including:
circuitry configured to
acquire sensor data, and
generate at least one output image in which recognition accuracy is reduced for at least one protection target in the acquired sensor data,
wherein the recognition accuracy for the at least one protection target is reduced in each generated output image according to learning using a selected model to recognize a specified protection target corresponding to the at least one protection target.
(2) The image generation apparatus according to (1), wherein the circuitry is configured to generate each output image in order to reduce the recognition accuracy for the at least one protection target within the output image by a parameter determined using at least one loss calculated based on a recognition score output by the selected model for the specified protection target.
(3) The image generation apparatus according to (1) or (2), wherein a type of the specified protection target is selected from among a plurality of types of protection targets in order to determine the selected model.
(4) The image generation apparatus according to any of (1) to (3), wherein the plurality of types of protection targets include one or more of a specific individual identity, a gender, an age, or a character similarity.
(5) The image generation apparatus according to any of (1) to (4), wherein the circuitry is further configured to adjust the determined parameter to adjust recognition accuracy for the specified protection target using the recognition score output by the selected model for the specified protection target when an input to the selected model includes one or more output images with reduced recognition accuracy.
(6) The image generation apparatus according to any of (1) to (5), wherein the circuitry is configured to adjust the determined parameter to increase recognition accuracy and reduce the recognition accuracy of the specified protection target.
(7) The image generation apparatus according to any of (1) to (6), wherein the circuitry is configured to generate the at least one output image in order to increase recognition accuracy of one or more objects in the acquired sensor data other than the at least one protection target, wherein the recognition accuracy is increased for the one or more objects in each generated output image according to one or more models different from the selected model, and wherein the one or more different models are trained to recognize the one or more objects corresponding to the one or more different models.
(8) The image generation apparatus according to any of (1) to (7), wherein the circuitry further includes at least one image sensor configured to acquire the sensor data.
(9) An image recognition apparatus including:
circuitry configured to
receive at least one output image in which recognition accuracy is reduced for at least one protection target in sensor data, and
perform recognition related to the at least one protection target in the at least one output image,
wherein the recognition accuracy for the at least one protection target is reduced in each generated output image according to learning using a selected model to recognize a specified protection target corresponding to the at least one protection target.
(10) The image recognition apparatus according to (9), wherein the recognition accuracy for the at least one protection target is reduced within the output image by a parameter determined using at least one loss calculated based on a recognition score output by the selected model for the specified protection target.
(11) The image recognition apparatus according to (9) or (10), wherein a type of the specified protection target is selected from among a plurality of types of protection targets in order to determine the selected model.
(12) The image recognition apparatus according to any of (9) to (11), wherein the type of the specified protection target is selected from the plurality of types of protection targets in accordance with a priority of each of the plurality of types of protection targets, a type of a task of performing recognition based on input data used in the learning, or a type of an application performing the task.
(13) The image recognition apparatus according to any of (9) to (12), wherein the type of the specified protection target is selected by the user from the plurality of types of protection targets.
(14) The image recognition apparatus according to any of (9) to (13), wherein the plurality of types of protection targets include one or more of a specific individual identity, a gender, an age, or a character similarity.
(15) The image recognition apparatus according to any of (9) to (14), wherein the determined parameter is adjusted to adjust the recognition accuracy for the specified protection target using the recognition score output by the selected model for the specified protection target when an input to the selected model includes one or more output images with reduced recognition accuracy.
(16) The image recognition apparatus according to any of (9) to (15), wherein the determined parameter is adjusted to increase recognition accuracy and reduce the recognition accuracy of the specified protection target.
(17) The image recognition apparatus according to any of (9) to (16), wherein the received at least one output image includes increased recognition accuracy of one or more objects in the sensor data other than the at least one protection target, wherein the recognition accuracy is increased for the one or more objects in each received output image according to one or more models different from the selected model, and wherein the one or more different models are trained to recognize the one or more objects corresponding to the one or more different models.
(18) The image recognition apparatus according to any of (9) to (17), wherein the circuitry is configured to perform recognition on a basis of the sensor data and a model obtained according to learning to increase accuracy of a task of performing recognition based on input data used in the learning.
(19) The image recognition apparatus according to any of (9) to (18), wherein the circuitry is configured to perform the task using a student model, and wherein the learning to reduce the recognition accuracy of the specified protection target and the learning to increase the accuracy of the task performed by the student model are performed using data obtained by a teacher model.
(20) An image recognition method including:
receiving at least one output image in which recognition accuracy is reduced for at least one protection target in sensor data; and
performing recognition related to the at least one protection target in the at least one output image,
wherein the recognition accuracy for the at least one protection target is reduced in each generated output image according to learning using a selected model to recognize a specified protection target corresponding to the at least one protection target.
(21) An information processing apparatus including:
an acquisition unit that acquires sensor data obtained as a result of performing processing relating to a signal output from a sensor on the basis of a parameter obtained as a result of acquiring protection target specification information for specifying a protection target and performing learning to reduce accuracy of recognition of the protection target specified by the protection target specification information; and
a recognition unit that performs recognition based on the sensor data.
(22) The information processing apparatus according to (21),
in which the protection target is specified by a user or a system from a plurality of candidates for the protection target.
(23) The information processing apparatus according to (22),
in which the protection target is specified from the plurality of candidates in accordance with a priority of each of the plurality of candidates, a type of a task of performing recognition based on input data used in the learning, or a type of an application that performs the task.
(24) The information processing apparatus according to (22),
in which the protection target is specified by the user from the plurality of candidates.
(25) The information processing apparatus according to any one of (21) to (24),
in which the protection target includes a feature of a person included in input data used in the learning, and
the feature of the person includes at least one of who the person is, a gender of the person, an age of the person, or a place where the person is present.
(26) The information processing apparatus according to any one of (21) to (25),
in which a loss used in the learning is calculated on the basis of a difference between a result of recognition of a feature of a person based on input data used in the learning and a ground truth label of the feature of the person included in the input data.
(27) The information processing apparatus according to (26),
in which the loss is calculated to be smaller as the difference is larger.
(28) The information processing apparatus according to (26),
in which the loss is calculated to be smaller as the difference is smaller, and a random value is set to the ground truth label.
(29) The information processing apparatus according to (21) or (22),
in which the parameter is obtained as a result of performing the learning to reduce the accuracy of recognition of the protection target and learning to increase accuracy of a task of performing recognition based on input data used in the learning.
(30) The information processing apparatus according to (21) or (22),
in which the recognition unit performs the recognition on the basis of a model obtained as a result of performing learning to increase accuracy of a task of performing recognition based on input data used in the learning, and the sensor data.
(31) The information processing apparatus according to (30),
in which the recognition unit performs the recognition on the basis of a model obtained as a result of performing the learning to increase the accuracy of the task and the learning to reduce the accuracy of recognition of the protection target, and the sensor data.
(32) The information processing apparatus according to (30),
in which the recognition unit includes a student model that performs the task, and the learning to reduce the accuracy of recognition of the protection target and the learning to increase the accuracy of the task performed by the student model are performed using data obtained by a teacher model.
(33) The information processing apparatus according to (21) or (22),
in which the learning to reduce the accuracy of recognition of the protection target is performed on the basis of a fact that input data used in the learning satisfies a predetermined condition.
(34) The information processing apparatus according to (33),
in which the predetermined condition includes a condition where a person is recognized from the input data.
(35) The information processing apparatus according to any one of (21) to (34),
in which the sensor includes an imaging unit that performs imaging, and the sensor data includes an image obtained on the basis of the imaging performed by the imaging unit.
(36) The information processing apparatus according to any one of (21) to (35),
in which the parameter includes a parameter used in at least one of remosaicing processing, defect correction, exposure time control, or analog gain adjustment.
(37) The information processing apparatus according to any one of (21) to (36),
in which the parameter includes a parameter used in at least one of demosaicing processing, sharpening processing, noise reduction, resolution conversion, digital gain adjustment, tone mapping, color correction, color conversion, normalization processing, or quantization.
(38) The information processing apparatus according to any one of (21) to (37),
in which the parameter includes a parameter used in at least one of resizing processing or cropping processing.
(39) An information processing method including:
causing a processor to acquire sensor data obtained as a result of performing processing relating to a signal output from a sensor on the basis of a parameter obtained as a result of acquiring protection target specification information for specifying a protection target and performing learning to reduce accuracy of recognition of the protection target specified by the protection target specification information; and
causing the processor to perform recognition based on the sensor data.
(40) A program causing a computer to function as an information processing apparatus, the information processing apparatus including:
an acquisition unit that acquires sensor data obtained as a result of performing processing relating to a signal output from a sensor on the basis of a parameter obtained as a result of acquiring protection target specification information for specifying a protection target and performing learning to reduce accuracy of recognition of the protection target specified by the protection target specification information; and
a recognition unit that performs recognition based on the sensor data.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10, 20 Information processing apparatus
110 Imaging unit
120 CIS signal processing unit
130 ISP unit
140 Preprocessing unit
151 Privacy information recognition unit
152 Object detection unit
153 Loss calculation unit
154 Parameter update unit
155 Weight update unit
160 Result output unit

1. An image generation apparatus comprising:
circuitry configured to acquire sensor data, and
generate at least one output image in which recognition accuracy is reduced for at least one protection target in the acquired sensor data, wherein the recognition accuracy for the at least one protection target is reduced in each generated output image according to learning using a selected model to recognize a specified protection target corresponding to the at least one protection target.

2. The image generation apparatus according to claim 1,
wherein the circuitry is configured to generate each output image in order to reduce the recognition accuracy for the at least one protection target within the output image by a parameter determined using at least one loss calculated based on a recognition score output by the selected model for the specified protection target.

3. The image generation apparatus according to claim 2,
wherein a type of the specified protection target is selected from among a plurality of types of protection targets in order to determine the selected model.

4. The image generation apparatus according to claim 3,
wherein the plurality of types of protection targets include one or more of a specific individual identity, a gender, an age, or a character similarity.

5. The image generation apparatus according to claim 3,
wherein the circuitry is further configured to adjust the determined parameter to adjust recognition accuracy for the specified protection target using the recognition score output by the selected model for the specified protection target when an input to the selected model includes one or more output images with reduced recognition accuracy.

6. The image generation apparatus according to claim 5,
wherein the circuitry is configured to adjust the determined parameter to increase recognition accuracy and reduce the recognition accuracy of the specified protection target.

7. The image generation apparatus according to claim 1,
wherein the circuitry is configured to generate the at least one output image in order to increase recognition accuracy of one or more objects in the acquired sensor data other than the at least one protection target, wherein the recognition accuracy is increased for the one or more objects in each generated output image according to one or more models different from the selected model, and
wherein the one or more different models are trained to recognize the one or more objects corresponding to the one or more different models.

8. The image generation apparatus according to claim 1,
wherein the circuitry further comprises at least one image sensor configured to acquire the sensor data.

9. An image recognition apparatus comprising:
circuitry configured to
receive at least one output image in which recognition accuracy is reduced for at least one protection target in sensor data, and
perform recognition related to the at least one protection target in the at least one output image,
wherein the recognition accuracy for the at least one protection target is reduced in each generated output image according to learning using a selected model to recognize a specified protection target corresponding to the at least one protection target.

10. The image recognition apparatus according to claim 9,
wherein the recognition accuracy for the at least one protection target is reduced within the output image by a parameter determined using at least one loss calculated based on a recognition score output by the selected model for the specified protection target.

11. The image recognition apparatus according to claim 10,
wherein a type of the specified protection target is selected from among a plurality of types of protection targets in order to determine the selected model.

12. The image recognition apparatus according to claim 11,
wherein the type of the specified protection target is selected from the plurality of types of protection targets in accordance with a priority of each of the plurality of types of protection targets, a type of a task of performing recognition based on input data used in the learning, or a type of an application performing the task.

13. The image recognition apparatus according to claim 11,
wherein the type of the specified protection target is selected by a user from the plurality of types of protection targets.

14. The image recognition apparatus according to claim 11,
wherein the plurality of types of protection targets include one or more of a specific individual identity, a gender, an age, or a character similarity.

15. The image recognition apparatus according to claim 11,
wherein the determined parameter is adjusted to adjust the recognition accuracy for the specified protection target using the recognition score output by the selected model for the specified protection target when an input to the selected model includes one or more output images with reduced recognition accuracy.

16. The image recognition apparatus according to claim 15,
wherein the determined parameter is adjusted to increase recognition accuracy and reduce the recognition accuracy of the specified protection target.

17. The image recognition apparatus according to claim 9,
wherein the received at least one output image includes increased recognition accuracy of one or more objects in the sensor data other than the at least one protection target,
wherein the recognition accuracy is increased for the one or more objects in each received output image according to one or more models different from the selected model, and
wherein the one or more different models are trained to recognize the one or more objects corresponding to the one or more different models.

18. The image recognition apparatus according to claim 9,
wherein the circuitry is configured to perform recognition on a basis of the sensor data and a model obtained according to learning to increase accuracy of a task of performing recognition based on input data used in the learning.

19. The image recognition apparatus according to claim 18,
wherein the circuitry is configured to perform the task using a student model, and
wherein the learning to reduce the recognition accuracy of the specified protection target and the learning to increase the accuracy of the task performed by the student model are performed using data obtained by a teacher model.

20. An image recognition method comprising:
receiving at least one output image in which recognition accuracy is reduced for at least one protection target in sensor data; and
performing recognition related to the at least one protection target in the at least one output image,
wherein the recognition accuracy for the at least one protection target is reduced in each generated output image according to learning using a selected model to recognize a specified protection target corresponding to the at least one protection target.
